(19) United States
(12) Patent Application Publication
(10) Pub. No.: US 2025/0003607 A1
(43) Pub. Date: Jan. 2, 2025

(54) NOISE REDUCTION APPARATUS AND AIR CLEANER INCLUDING THE SAME

(71) Applicant: SAMSUNG ELECTRONICS CO., LTD., Suwon-si (KR)

(72) Inventors: Incheol LEE, Suwon-si (KR); Wonjun JANG, Suwon-si (KR); Ho CHOI, Suwon-si (KR); Hooijoong KIM, Suwon-si (KR); Eungryeol SEO, Suwon-si (KR); Nokhaeng LEE, Suwon-si (KR); Jeawon LEE, Suwon-si (KR)

(73) Assignee: SAMSUNG ELECTRONICS CO., LTD., Suwon-si (KR)

(21) Appl. No.: 18/679,782

(22) Filed: May 31, 2024

Related U.S. Application Data
(63) Continuation of application No. PCT/KR2024/007236, filed on May 28, 2024.

(30) Foreign Application Priority Data
Jun. 27, 2023 (KR) 10-2023-0083022

(51) Int. Cl. F24F 1/028; F24F 1/035; F24F 13/08; F24F 13/24

(52) U.S. Cl. CPC F24F 1/028; F24F 1/035; F24F 13/08; F24F 2013/242; F24F 2013/245

(57) ABSTRACT

An air cleaner including a housing including a flow path through which air is movable; a fan configured to operate to move air through the flow path; and an air guide adjacent to the fan, the air guide including a guide surface along which the air moving through the flow path flows while the fan operates, and a sound absorption hole extending from the guide surface so that a sound generated by the fan while the fan operates is absorbed through the sound absorption hole.

### CROSS-REFERENCE TO RELATED APPLICATIONS

This application is a continuation application, under 35 U.S.C. § 111 (a), of International Application No. PCT/KR2024/007236, filed on May 28, 2024, which claims priority under 35 U.S.C. § 119 to Korean Patent Application 10-2023-0083022, filed on Jun. 27, 2023, in the Korean Intellectual Property Office, the disclosures of which are incorporated by reference herein in their entireties.

### TECHNICAL FIELD

The present disclosure relates to an air cleaner, and more particularly, to an air cleaner including a fan.

### BACKGROUND ART

An air cleaner is an apparatus for taking in indoor air, conditioning the air and then discharging the air. Air conditioning refers to appropriately controlling the temperature, humidity, cleanliness, and airflow distribution of indoor air. The kinds of air conditioners include ventilation apparatuses, heating and cooling systems, air cleaners, humidifiers, etc.

As an example of the air conditioners, an air cleaner is used to adjust the cleanliness of indoor air by removing pollutants in the air. The air cleaner removes bacteria, viruses, mold, fine dust, and chemicals causing bad odors, which exist in the air.

The air cleaner includes a filter for purifying polluted indoor air. While air taken into the air cleaner passes through the filter, pollutants existing in the air are removed so that the air is purified into clean air and the purified air is discharged to the outside of the air cleaner. Lately, a heating and cooling system, which is an example of the air conditioners, also includes a filter unit to perform an air purifying function.

An air conditioner includes a fan for taking in and discharging air. The fan has a fan inlet through which air moves toward the fan.

The filter or filter unit and the fan inlet may differ in cross section. To move air with minimum energy loss, a flow adjacent to the filter and a flow adjacent to the fan inlet need to have a laminar flow.

Also, while the fan operates, noise may generate. The noise needs to be reduced.

### DISCLOSURE

### Technical Problem

It is an aspect of the disclosure to prevent unnecessary sounds from being emitted to outside of an air cleaner by absorbing sounds generated while a fan operates.

It is an aspect of the disclosure to provide an air cleaner for reducing, while a fan operates to move air, a sound generated by the fan despite the movement of air.

It is an aspect of the disclosure to provide an air cleaner capable of absorbing a sound generated while a fan operates by including a noise reduction apparatus having a meta structure without using a thick sound insulation.

It is an aspect of the disclosure to provide an air cleaner capable of reducing noise without increasing a size of a housing by including a noise reduction apparatus that is accommodatable between a fan and the housing.

The technical object intended to be achieved by the present document is not limited to the above-mentioned technical objects, and other technical objects not mentioned will be clearly understood by one of ordinary skill in the technical art to which the disclosure belongs from the following description.

### Technical Solution

Aspects of embodiments of the disclosure will be set forth in part in the description which follows and, in part, will be apparent from the description, or may be learned by practice of the presented embodiments.

According to an embodiment of the disclosure, an air cleaner may include a housing including a flow path through which air is movable; a fan configured to operate to move air through the flow path; and an air guide adjacent to the fan, the air guide including a guide surface along which the air moving through the flow path flows while the fan operates, and a sound absorption hole extending from the guide surface so that a sound generated by the fan while the fan operates is absorbed through the sound absorption hole.

According to an embodiment of the disclosure, the air guide may include a guide portion including the guide surface and the sound absorption hole; and a space forming portion defining the sound insulation space between the space forming portion and the guide portion. The guide surface may be on one side of the guide portion which is opposite to another side of the guide portion facing the sound insulation. The sound absorption hole may extend from the guide surface through the guide portion to the sound insulation space.

According to an embodiment of the disclosure, a volume of the sound absorption hole may be smaller than a volume of the sound insulation space, to thereby prevent a sound wave generated while the fan operates from moving from the sound insulation space through the sound absorption hole.

According to an embodiment of the disclosure, the air guide may have a resonant frequency defined by the sound absorption hole and the sound insulation space so that, when a frequency of the generated sound is identical to the resonant frequency of the air guide, the air guide reduces the generated sound.

According to an embodiment of the disclosure, the air guide may include a separating partition extending from the space forming portion toward the guide portion and partitioning the sound insulation space into a first sound insulation space and a second sound insulation space having a different volume from the first sound insulation space, a first sound insulation unit defining the first sound insulation space and having a resonant frequency, and a second sound insulation unit defining the second sound insulation space and having a resonant frequency that is different from the resonant frequency of the first sound insulation unit.

According to an embodiment of the disclosure, the sound absorption hole may be a sound absorption hole among a plurality of first sound absorption holes and a plurality of second sound absorption holes. The plurality of first sound absorption holes may correspond to the first sound insulation space. The plurality of second sound absorption holes may correspond to the second sound insulation space. A number of sound absorption holes of the plurality of first sound absorption holes for a volume of the first sound insulation space may be different from a number of sound absorption holes of the plurality of second sound absorption holes for a volume of the second sound insulation space, such that the resonant frequency of the first sound insulation unit is different from the resonant frequency of the second sound insulation unit.

According to an embodiment of the disclosure, the sound absorption hole may be a sound absorption hole among a plurality of sound absorption holes including a first sound absorption hole corresponding to the first sound insulation space, and a second sound absorption hole corresponding to the second sound insulation space. A diameter of the first sound absorption hole may be different from a diameter of the second sound absorption hole, such that the resonant frequency of the first sound insulation unit is different from the resonant frequency of the second sound insulation unit.

According to an embodiment of the disclosure, a diameter of the sound absorption hole may be less than 2.0 mm, so as to prevent a sound from resonating by the air moving through the flow path while the fan operates.

According to an embodiment of the disclosure, the sound absorption hole may penetrate the guide portion so as to prevent a distance between two points on an opening of the sound absorption hole from being greater than 2.0 mm.

According to an embodiment of the disclosure, the air guide may be configured to reduce a sound in a frequency region of 1000 Hz or less among frequencies of sounds generated while the fan operates. The air guide may have a meta structure in which a density of air being adjacent to the sound absorption hole has a negative value.

According to an embodiment of the disclosure, the fan may include a fan inlet having a first cross-sectional area. A filter having a second cross-sectional area that is larger than the first cross-sectional area may be installable in the air cleaner so as to be spaced apart from the fan. When the filter is installed in the air cleaner, the guide portion may include a guide flow path of which a cross-sectional area is reduced toward the fan inlet from the filter to prevent, while the fan operates, air passed through the filter and moving toward the fan inlet from forming turbulence.

According to an embodiment of the disclosure, the fan may include a blade, a fan outlet, and a shroud positioned between the blade and the air guide, the shroud extending radially from a center of rotation of the blade toward the fan outlet along an axis of rotation of the blade. The air guide may include a flow induction flow path of which a cross-sectional area increases gradually toward the shroud from an end of the guide flow path such that air moves in an extension direction of the shroud while the fan operates.

According to an embodiment of the disclosure, the sound absorption hole may correspond one-to-one to the sound insulation space such that the air guide includes a Helmholtz resonance structure.

According to an embodiment of the disclosure, a length to which the sound insulation space extends may be ¼ of a wavelength of the generated sound.

According to an embodiment of the disclosure, the air guide may be spaced in a radial direction from a center of rotation of the fan and extends about the center of rotation of the fan in a circumferential direction. The sound insulation space may be positioned between the air guide and the housing.

An air cleaner according to an embodiment of the disclosure may include a housing having an inlet and an outlet, a filter positioned inside the housing, a fan configured to move air from the filter to the outlet of the housing, the fan having a fan inlet through which air passes and which has a smaller cross-sectional area than a cross-sectional area of the filter, and an air guide positioned between the fan and the filter and having a guide flow path of which a cross-sectional area is reduced toward the fan. The air guide may have a sound absorption hole configured to absorb a sound generated while the fan operates, the sound absorption hole communicating with the sound insulation space.

A noise reduction apparatus according to an embodiment of the disclosure may include an air guide positioned adjacent to a fan, wherein the air guide may include a guide main body, a sound insulation space positioned inside the guide main body, and a sound absorption hole opening toward the fan to absorb a sound generated while the fan or a motor operates, communicating with the sound insulation space, and having a smaller volume than the sound insulation space.

### DESCRIPTION OF DRAWINGS

These and/or other embodiments of the disclosure will become apparent and more readily appreciated from the following description of the embodiments, taken in conjunction with the accompanying drawings of which:

FIG. 1 is a perspective view of an air cleaner according to an embodiment of the disclosure.

FIG. 2 is an exploded view of the air cleaner shown in FIG. 1.

FIG. 3 is a cross-sectional view of the air cleaner shown in FIG. 1.

FIG. 4 is a perspective view of a noise reduction apparatus shown in FIG. 3.

FIG. 5 is a perspective view of a filter air guide shown in FIG. 4.

FIG. 6 is an enlarged cross-sectional perspective view resulting from cutting and enlarging the filter air guide shown in FIG. 5.

FIG. 7 is an enlarged cross-sectional view resulting from cutting and enlarging the filter air guide shown in FIG. 5.

FIG. 8 is a conceptual diagram conceptually showing a principle of absorbing a sound in the filter air guide shown in FIG. 7.

FIG. 9 is a cross-sectional view showing a flow of air through the filter air guide shown in FIG. 5.

FIG. 10 is a graph showing a noise reduction effect by the filter air guide shown in FIG. 9.

FIG. 11 is an enlarged cross-sectional view of a portion of the filter air guide shown in FIG. 9.

FIG. 12 is a perspective view of a fan air guide shown in FIG. 4.

FIG. 13 is an enlarged cross-sectional perspective view resulting from cutting and enlarging the fan air guide shown in FIG. 12.

FIG. 14 is a cross-sectional view showing the fan air guide shown in FIG. 12 and a component for reducing noise together according to an embodiment of the disclosure.

FIG. 15 is a graph showing a sound absorption effect of the fan air guide shown in FIG. 14, which includes a sound absorption hole having a diameter of 0.5 mm.

FIG. 16 is a graph showing a sound absorption effect of the fan air guide shown in FIG. 14, which includes a sound absorption hole having a diameter of 1.0 mm.

FIG. 17 is a graph showing a sound absorption effect of the fan air guide shown in FIG. 14, which includes a sound absorption hole having a diameter of 2.0 mm.

FIG. 18 is a cross-sectional view showing the filter air guide and the fan air guide shown in FIG. 4 and a component for reducing noise together according to an embodiment of the disclosure.

FIG. 19 is a graph showing a noise reduction effect of the filter air guide and the fan air guide shown in FIG. 18 in a front direction of the air cleaner.

FIG. 20 is a graph showing a noise reduction effect of the filter air guide and the fan air guide shown in FIG. 18 in a rear direction of the air cleaner.

FIG. 21 is a cross-sectional view of a filter air guide of an air cleaner according to an embodiment of the disclosure.

FIG. 22 is a cross-sectional view of a filter air guide of an air cleaner according to an embodiment of the disclosure.

FIG. 23 is an enlarged perspective view of a filter air guide of an air cleaner according to an embodiment of the disclosure.

FIG. 24 is a graph showing a noise reduction effect by the filter air guide shown in FIG. 23.

FIG. 25 is an enlarged perspective view of a filter air guide of an air cleaner according to an embodiment of the disclosure.

FIG. 26 is a graph showing a noise reduction effect by the filter air guide shown in FIG. 25.

### MODES OF THE INVENTION

Various embodiments of the present document and terms used therein are not intended to limit the technical features described in this document to specific embodiments, and should be understood to include various modifications, equivalents, or substitutes of the corresponding embodiments.

In connection with the description of the drawings, similar reference numerals may be used for similar or related components.

The singular form of a noun corresponding to an item may include one or a plurality of the items unless clearly indicated otherwise in a related context.

In this document, phrases, such as “A or B”, “at least one of A and B”, “at least one of A or B,” “A, B or C,” “at least one of A, B and C,” and “at least one of A, B, or C”, may include any one or all possible combinations of items listed together in the corresponding phrase among the phrases.

As used herein, the term “and/or” includes any and all combinations of one or more of associated listed items.

Terms such as “first”, “second”, “1st”, or “2nd” may be used simply to distinguish a component from other components, without limiting the component in other aspects (e.g., importance or order).

A certain (e.g., a first) component is referred to as “coupled” or “connected” with or without the terms “functionally” or “communicatively” to another (e.g., second) component. When mentioned, it means that the component can be connected to the other component directly (e.g., by wire), wirelessly, or via a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

It will be understood that when a certain component is referred to as being “connected to”, “coupled to”, “supported by” or “in contact with” another component, it can be directly or indirectly connected to, coupled to, supported by, or in contact with the other component. When a component is indirectly connected to, coupled to, supported by, or in contact with another component, it may be connected to, coupled to, supported by, or in contact with the other component through a third component.

It will also be understood that when a component is referred to as being “on” or “over” another component, it can be directly on the other component or intervening components may also be present.

Meanwhile, in the following description, the terms “up-down direction”, “lower portion”, “front-rear direction”, etc. are defined based on the drawings, and the shapes and positions of the components are not limited by the terms.

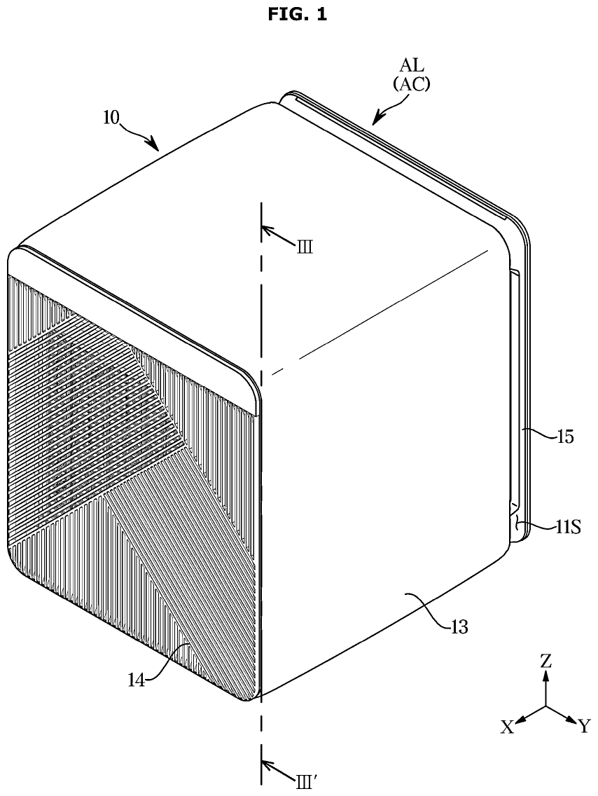

More specifically, as shown in FIG. 1, a direction which a door of an air cleaner AL faces may be defined as a front direction, and rear, left/right, and upper/lower directions may be defined based on the front direction.

Also, as shown in FIG. 1, a +X direction may be defined as a front direction, a +Y direction may be defined as a left direction, and a +Z direction may be defined as an upper direction.

In the disclosure, a “resonant frequency” may mean a “characteristic frequency” or a “natural frequency”.

A concept of the disclosure may be applied to an air conditioner AC. The drawings of the disclosure are shown under an assumption that an embodiment relates to an air cleaner AL. However, the concept of the disclosure may also be applied to an air conditioner AC.

Hereinafter, first, an embodiment of an air conditioner AC to which the concept of the disclosure is applicable will be described. After the air conditioner AC is described, an air cleaner AL according to an embodiment of the disclosure will be described.

An air conditioner AC according to various embodiments may be an apparatus for performing at least one of functions of air purifying, ventilation, humidity adjustment, cooling, heating, etc. in a space (hereinafter, referred to as ‘indoor’) to be air-conditioned.

According to an embodiment, the air conditioner AC may include a heat pump for performing a cooling function or a heating function. The heat pump may include a refrigerating cycle in which a refrigerant is circulated along a compressor, a first heat exchanger, an expander, and a second heat exchanger. All components of the heat pump may be installed in a single housing forming an appearance of the air conditioner AC, and a window-type air conditioner or a portable type air conditioner may correspond to the air conditioner AC. Meanwhile, components of a heat pump may be divided and installed in a plurality of housings forming a single air conditioner AC, and a wall-mounted type air conditioner, a stand-type air conditioner, and a system air conditioner may correspond to the air conditioner AC.

The air conditioner AC including the plurality of housings may include at least one outdoor unit installed outdoor and at least one indoor unit installed indoor. For example, the air conditioner AC may connect an outdoor unit to an indoor unit through a refrigerant pipe. For example, the air conditioner AC may connect an outdoor unit to two or more indoor units through refrigerant pipes. For example, the air conditioner AC may connect two or more outdoor units to two or more indoor units through a plurality of refrigerant pipes.

The outdoor unit may be electrically connected to the indoor unit. For example, information (or a command) for controlling the air conditioner AC may be input through an input interface provided in the outdoor unit or the indoor unit, and the outdoor unit and the indoor unit may operate simultaneously or sequentially in response to a user input.

The air conditioner AC may include an outdoor heat exchanger provided in the outdoor unit, an indoor heat exchanger provided in the indoor unit, and the refrigerant pipe connecting the outdoor heat exchanger to the indoor heat exchanger.

The outdoor heat exchanger may perform heat exchange between a refrigerant and outside air by using a phase change (for example, evaporation or condensation) of the refrigerant. For example, while the refrigerant is condensed in the indoor heat exchanger, the refrigerant may emit heat to outside air, and, while the refrigerant flowing through the outdoor heat exchanger is evaporated, the refrigerant may absorb heat from outside air.

The indoor unit may be installed indoor. For example, the indoor unit may be classified into a ceiling type indoor unit, a stand type indoor unit, and a wall-mounted type indoor unit. For example, the ceiling type indoor unit may be classified into a four-way type indoor unit, a one-way type indoor unit, and a duct-type indoor unit according to methods by which air is discharged.

Likewise, the indoor heat exchanger may perform heat exchange between the refrigerant and indoor air by using a phase change (for example, evaporation or condensation) of the refrigerant. For example, while the refrigerant is evaporated in the indoor unit, the refrigerant may absorb heat from indoor air, and by blowing indoor air cooled by passing through the cooled indoor heat exchanger, an indoor space may be cooled. Also, while the refrigerant is condensed in the indoor heat exchanger, the refrigerant may emit heat to indoor air, and by blowing indoor air heated by passing through the high-temperature indoor heat exchanger, the indoor space may be heated.

That is, the air conditioner AC may perform a cooling or heating function through the phase-change process of the refrigerant that circulates between the outdoor heat exchanger and the indoor heat exchanger, and for the circulation of the refrigerant, the air conditioner AC may include the compressor that compresses the refrigerant. The compressor may take in a refrigerant gas through an inlet and compress the refrigerant gas. The compressor may discharge a high-temperature and high-pressure refrigerant gas through an outlet. The compressor may be installed inside the outdoor unit.

A refrigerant may circulate through the refrigerant pipe in the order of the compressor, the outdoor heat exchanger, the expander, and the indoor heat exchanger or in the order of the compressor, the indoor heat exchanger, the expander, and the outdoor heat exchanger.

For example, in the air conditioner AC, an outdoor unit may be directly connected to an indoor unit through a refrigerant pipe, and in this case, a refrigerant may circulate between the outdoor unit and the indoor unit through the refrigerant pipe.

For example, in the air conditioner AC, an outdoor unit may be connected to two or more indoor units through refrigerant pipes, and in this case, a refrigerant may flow to a plurality of indoor units through the refrigerant pipes diverging from the outdoor unit. Refrigerants discharged from the plurality of indoor units may be joined and circulate to the outdoor unit. For example, the plurality of indoor units may be connected in parallel to the outdoor unit through separate refrigerant pipes.

The plurality of indoor units may operate independently according to operation modes set by a user. A part of the plurality of indoor units may operate in a cooling mode, and simultaneously, another part of the plurality of indoor units may operate in a heating mode. In this case, a refrigerant may enter each of the indoor units in a high or low pressure state selectively along a circulation flow path designated through a flow path switching valve which will be described below, be discharged, and then circulate to the outdoor unit.

For example, in the air conditioner AC, two or more outdoor units may be connected to two or more indoor units through a plurality of refrigerant pipes, and in this case, refrigerants discharged from a plurality of outdoor units may be joined, flow through a single refrigerant pipe, then diverge at a certain location, and enter a plurality of indoor units.

All of the plurality of outdoor units may operate or at least some of the plurality of outdoor units may not operate according to a driving load depending on a driving amount of the plurality of indoor units. In this case, the refrigerant may enter the outdoor units that selectively operate through the flow path switching valve, and circulate. The air conditioner AC may include the expander for lowering pressure of the refrigerant that enters the heat exchanger. For example, the expander may be positioned inside the indoor unit or the outdoor unit or inside both the indoor unit and the outdoor unit.

The expander may lower temperature and pressure of the refrigerant by using, for example, a throttling effect. The expander may include an orifice capable of reducing a cross-sectional area of a flow path. The refrigerant passed through the orifice may be lowered in temperature and pressure.

The expander may be implemented as an electronic expansion valve capable of adjusting an opening rate (a ratio of a cross-sectional area of the flow path of the valve in a partially open state with respect to a cross-sectional area of the flow path of the valve in a fully open state). An amount of a refrigerant passing through the expander may be controlled depending on an opening rate of the electronic expansion valve.

The air conditioner AC may further include the flow path switching valve positioned on the refrigerant circulation flow path. The flow path switching valve may include, for example, a 4-way valve. The flow path switching valve may set a circulation path of a refrigerant depending on a driving mode (for example, cooling driving or heating driving) of the indoor unit. The flow path switching valve may be connected to the outlet of the compressor.

The air conditioner AC may include an accumulator. The accumulator may be connected to the inlet of the compressor. A low-temperature and low-pressure refrigerant evaporated from the indoor heat exchanger or the outdoor heat exchanger may enter the accumulator.

While a refrigerant being a mixture of a refrigerant liquid and a refrigerant gas enters the accumulator, the accumulator may separate the refrigerant liquid from the refrigerant gas and provide the refrigerant gas from which the refrigerant liquid has been separated to the compressor.

An outdoor fan may be provided around the outdoor heat exchanger. The outdoor fan may blow outside air to the outdoor heat exchanger to facilitate heat exchange between a refrigerant and outside air.

The outdoor unit of the air conditioner AC may include at least one sensor. For example, the outdoor unit may include an environment sensor. The sensor of the outdoor unit may be positioned inside the outdoor unit or at an arbitrary location outside the outdoor unit. For example, the sensor of the outdoor unit may include a temperature sensor for detecting temperature of air around the outdoor unit, a humidity sensor for detecting humidity of air around the outdoor unit, a refrigerant temperature sensor for detecting refrigerant temperature of a refrigerant pipe passing through the outdoor unit, or a refrigerant pressure sensor for detecting refrigerant pressure of the refrigerant pipe passing through the outdoor unit.

The outdoor unit of the air conditioner AC may include an outdoor unit communicator. The outdoor unit communicator may receive a control signal from a controller of the indoor unit of the air conditioner AC, which will be described below. The outdoor unit may control an operation of the compressor, the outdoor heat exchanger, the expander, the flow path switching valve, the accumulator, or the outdoor fan, based on a control signal received through the outdoor unit communicator. The outdoor unit may transmit a sensing value detected by the sensor of the outdoor unit to the controller of the indoor unit through the outdoor unit communicator.

The indoor unit of the air conditioner AC may include a housing, a blower that circulates air into or out of the housing, and the indoor heat exchanger that exchanges heat with air entered the housing.

The housing may include an inlet. Indoor air may enter the housing through the inlet.

The indoor unit of the air conditioner AC may include a filter that filters a foreign material from air entered the housing through the inlet.

The housing may include an outlet. An air flowing inside the housing may be discharged to outside of the housing through the outlet.

In the housing of the indoor unit, an airflow guide for guiding a direction of air to be discharged through the outlet may be provided. For example, the airflow guide may include a blade positioned on the outlet. For example, the airflow guide may include an auxiliary fan for adjusting a discharge airflow, although not limited thereto. However, the airflow guide may be omitted.

Inside the housing of the indoor unit, the indoor heat exchanger and the blower may be positioned on a flow path connecting the inlet to the outlet.

The blower may include an indoor fan and a fan motor. For example, the indoor fan may include an axial flow fan, a mixed flow fan, a cross flow fan, and a centrifugal fan.

The indoor heat exchanger may be positioned between the blower and the outlet or between the inlet and the blower. The indoor heat exchanger may absorb heat from air entered through the inlet or transfer heat to air entered through the inlet. The indoor heat exchanger may include a heat exchange pipe through which a refrigerant flows and a heat exchange fin that is in contact with the heat exchange pipe to increase a heat transfer area.

The indoor unit of the air conditioner AC may include a drain tray positioned below the indoor heat exchanger to collect condensed water generated in the indoor heat exchanger. Condensed water accommodated in the drain tray may be discharged to the outside through a drain hose. The drain tray may support the indoor heat exchanger.

The indoor unit of the air conditioner AC may include an input interface. The input interface may include an arbitrary type of user input device including a button, a switch, a touch screen, and/or a touch pad. A user may himself/herself input setting data (for example, desired room temperature, a driving mode setting for cooling/heating/dehumidifying/air cleaning, an outlet selection setting, and/or an air volume setting) through the input interface.

The input interface may also be connected to an external input device. For example, the input interface may be electrically connected to a wired remote controller. The wired remote controller may be installed in a certain location (for example, a part of a wall) of an indoor space. The user may input setting data for an operation of the air conditioner AC by controlling the wired remote controller. An electrical signal corresponding to the setting data obtained through the wired remote controller may be transmitted to the input interface. Also, the input interface may include an infrared sensor. The user may input setting data for an operation of the air conditioner AC remotely by using a wireless remote controller. The setting data input through the wireless remote controller may be transmitted as an infrared signal to the input interface.

Also, the input interface may include a microphone. A user's voice command may be obtained through the microphone. The microphone may convert the user's voice command into an electrical signal and transfer the converted electrical signal to an indoor unit controller. The indoor unit controller may control components of the air conditioner AC to execute a function corresponding to the user's voice command. The setting data (for example, desired room temperature, a driving mode setting for cooling/heating/dehumidifying/air cleaning, an outlet selection setting, and/or an air volume setting) obtained through the input interface may be transferred to the indoor unit controller which will be described below. According to an example, setting data obtained through the input interface may be transmitted to an external device, that is, the outdoor unit or a server through an indoor unit communicator which will be described below.

The indoor unit of the air conditioner AC may include a power module. The power module may be connected to an external power source to supply power to components of the indoor unit.

The indoor unit of the air conditioner AC may include an indoor unit sensor. The indoor unit sensor may be an environment sensor positioned in an inside or outside space of the housing. For example, the indoor unit sensor may include one or more temperature sensors and/or humidity sensors positioned in a preset space inside or outside the housing of the indoor unit. For example, the indoor unit sensor may include a refrigerant temperature sensor for detecting refrigerant temperature of a refrigerant pipe passing through the indoor unit. For example, the indoor unit sensor may include a refrigerant temperature sensor that detects temperature at each of an entrance, middle part, and/or exit of the refrigerant pipe passing through the indoor heat exchanger.

For example, environment information detected by the indoor unit sensor may be transferred to the indoor unit controller which will be described below or transmitted to the outside through the indoor unit communicator which will be described below.

The indoor unit of the air conditioner AC may include the indoor unit communicator. The indoor unit communicator may include at least one of a short-range communication module or a long-distance communication module. The indoor unit communicator may include at least one antenna for wirelessly communicating with another device. The outdoor unit may include an outdoor unit communicator. The outdoor unit communicator may also include at least one of a short-range communication module or a long-distance communication module.

The short-range wireless communication module may include a Bluetooth communication module, a Bluetooth Low Energy (BLE) communication module, a Near Field Communication (NFC) module, a Wireless Local Area Network (WLAN; WiFi) communication module, a Zigbee communication module, an Infrared Data Association (IrDA) communication module, a Wi-Fi Direct (WFD) communication module, a ultrawideband (UWB) communication module, an Ant+ communication module, a microwave (uWave) communication module, etc., although not limited thereto.

The long-distance wireless communication module may include a communication module that performs various kinds of long-distance communications, and may include a mobile communicator. The mobile communicator may transmit/receive a wireless signal to/from at least one of a base station, an external terminal, or a server on a mobile communication network.

The indoor unit communicator may communicate with an external device, such as a server, a mobile device, another home appliance, etc., through a surrounding Access Point (AP). The AP may connect a Local Area Network (LAN) to which the air conditioner AC or a user device is connected to a Wide Area Network (WAN) to which a server is connected. The air conditioner AC or the user device may be connected to the server through the WAN. The indoor unit of the air conditioner AC may include the indoor unit controller that controls the components of the indoor unit, including the blower, etc. The outdoor unit of the air conditioner AC may include an outdoor unit controller that controls the components of the outdoor unit, including the compressor, etc. The indoor unit controller may communicate with the outdoor unit controller through the indoor unit communicator and the outdoor unit communicator. The outdoor unit communicator may transmit a control signal generated by the outdoor unit controller to the indoor unit communicator, or transfer a control signal transmitted from the indoor unit communicator to the outdoor unit controller. That is, the outdoor unit and the indoor unit may perform bidirectional communication. The outdoor unit and the indoor unit may transmit and receive various signals generated while the air conditioner AC operates.

The outdoor unit controller may be electrically connected to the components of the outdoor unit and control operations of the individual components. For example, the outdoor unit controller may adjust a frequency of the compressor, and control the flow path switching valve to switch a circulation direction of a refrigerant. The outdoor unit controller may adjust a rotation speed of the outdoor fan. Also, the outdoor unit controller may generate a control signal for adjusting an opening rate of the expansion valve. A refrigerant may circulate along a refrigerant circulation circuit including the compressor, the flow path switching valve, the outdoor heat exchanger, the expansion valve, and the indoor heat exchanger, under a control by the outdoor unit controller.

Various temperature sensors included in the outdoor unit and the indoor unit may each transmit an electrical signal corresponding to detected temperature to the outdoor unit controller and/or the indoor unit controller. For example, the humidity sensors included in the outdoor unit and the indoor unit may each transmit an electrical signal corresponding to detected humidity to the outdoor unit controller and/or the indoor unit controller.

The indoor unit controller may obtain a user input from a user device including a mobile device, etc. through the indoor unit communicator, or obtain a user input directly through the input interface or through the remote controller. The indoor unit controller may control the components of the indoor unit, including the blower, etc. in response to the received user input. The indoor unit controller may transmit information related to the received user input to the outdoor unit controller of the outdoor unit.

The outdoor unit controller may control the components of the outdoor unit including the compressor, etc. based on the information about the user input, received from the indoor unit. For example, according to reception of a control signal corresponding to a user input of selecting a driving mode, such as cooling driving, heating driving, blowing driving, defrosting driving, or dehumidifying driving, from the indoor unit, the outdoor unit controller may control the components of the outdoor unit to perform an operation of the air conditioner AC corresponding to the selected driving mode.

Each of the indoor unit controller and the indoor unit controller may include a processor and a memory. The indoor unit controller may include at least one first processor and at least one first memory, and the outdoor unit controller may include at least one second processor and at least one second memory.

The memory may memorize/store various information required for operations of the air conditioner AC. The memory may store instructions, applications, data, and/or programs required for the operations of the air conditioner AC. For example, the memory may store various programs for cooling driving, heating driving, dehumidifying driving, and/or defrosting driving of the air conditioner AC. The memory may include a volatile memory, such as Static Random Access Memory (S-RAM) and Dynamic Random Access Memory (D-RAM), for temporarily memorizing data. Also, the memory may include a non-volatile memory, such as Read Only Memory (ROM), Erasable Programmable Read Only Memory (EPROM), Electrically Erasable Programmable Read Only Memory (EEPROM), for storing data for a long time.

The processor may generate a control signal for controlling the operations of the air conditioner AC based on the instructions, applications, data, and/or programs stored in the memory. The processor may include a logic circuit and an arithmetic circuit, as hardware. The processor may process data according to a program and/or instruction provided from the memory, and generate a control signal according to the processed result. The memory and processor may be implemented as a single control circuit or a plurality of circuits.

The indoor unit of the air conditioner AC may include an output interface. The output interface may be electrically connected to the indoor unit controller, and output information related to an operation of the air conditioner AC under a control by the indoor unit controller. For example, information, such as a driving mode, a direction of wind, an air volume, and temperature, selected by a user input may be output. Also, the output interface may output sensing information and a warning/error message obtained from an indoor unit sensor or an outdoor unit sensor.

The output interface may include a display and a speaker. The speaker, which is a sound system, may output various sounds. The display may display information input by the user or information to be provided to the user, as various graphic elements. For example, operation information of the air conditioner AC may be displayed as at least one of an image or text. Also, the display may include an indicator that provides specific information. The display may include a Liquid Crystal Display Panel (LCD) panel, a Light Emitting Diode Panel (LED) panel, an Organic Light Emitting Diode (OLED) panel, a micro LED panel, and/or a plurality of LEDs.

So far, the air conditioner AC has been described as an embodiment to which the concept of the disclosure is applicable. Hereinafter, an air cleaner AL will be described as an embodiment to which the concept of the disclosure is applicable. The air cleaner AL may be included in the air conditioner AC.

Hereinafter, an embodiment of the disclosure will be described in detail with reference to the accompanying drawings.

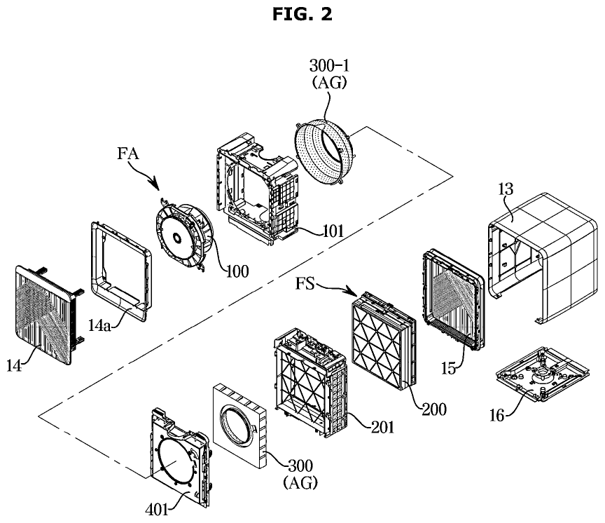

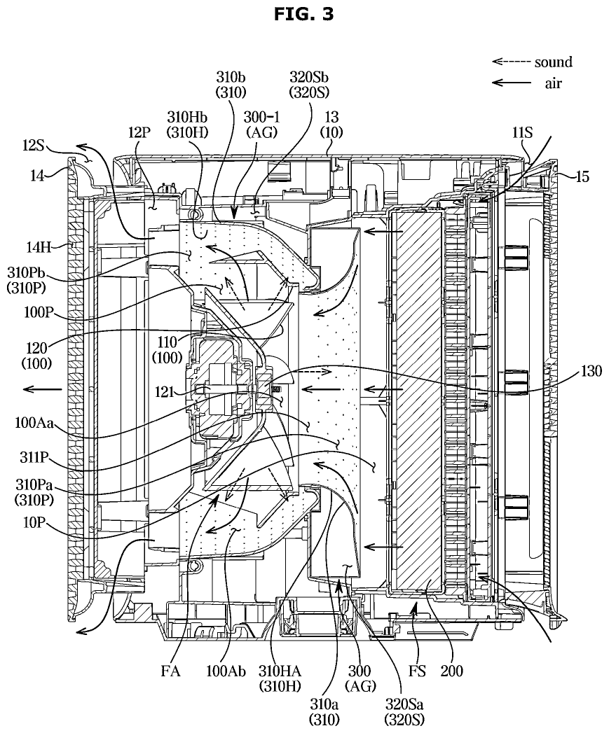

FIG. 1 is a perspective view of an air cleaner AL according to an embodiment of the disclosure, FIG. 2 is an exploded view of the air cleaner AL shown in FIG. 1, and FIG. 3 is a cross-sectional view of the air cleaner AL shown in FIG. 1.

The air cleaner AL according to an embodiment of the disclosure will be described with reference to FIGS. 1 to 3.

The air cleaner AL may be positioned indoor, and in this case, indoor air may move to inside of the air cleaner AL, be purified, and then move to outside of the air cleaner AL.

As shown in FIG. 1, the air cleaner AL may include a housing 10. The housing 10 may form an appearance of the air cleaner AL.

The housing 10 may be substantially in a shape of a rectangular parallelepiped. To increase sense of beauty, the housing 10 may be substantially in a shape of a regular hexahedron.

The housing 10 may form an internal space therein. In the internal space of the housing 10, components for purifying air may be positioned. The housing 10 may protect the components for purifying air to prevent an impact from being applied to the components for purifying air.

Air may move to inside of the housing 10, be purified, and then move to outside of the housing 10. The housing 10 may have a flow path 10P along which air is movable. Air may move inside the housing 10 through the flow path 10P formed by the housing 10.

The housing 10 may be formed of plastic, although not limited thereto.

The housing 10 may be formed by injection molding, although not limited thereto.

The housing 10 may include a front panel 14. The front panel 14 may be positioned in a front portion of the housing 10. The front panel 14 may form a front appearance of the air cleaner AL.

The front panel 14 may have a fine outlet 14H. The fine outlet 14H may be a slit or hole. Air moved to the inside of the air cleaner AL may move to the outside of the air cleaner AL through the slit or hole of the front panel 14.

The front panel 14 may form an opening or space communicating with the inside of the housing 10 by being spaced from a portion of the housing 10. Air may move to the inside of the housing 10 through the opening or space formed by the front panel 14.

The fine outlet 14H being the slit or hole of the front panel 14 or the opening or space formed by the front panel 14 is referred to as an outlet 12S.

The housing 10 may include a rear panel 15. The rear panel 15 may be positioned in a rear portion of the housing 10. The rear panel 15 may form a rear appearance of the air cleaner AL.

The rear panel 15 may have a slit or hole. While air moves to the inside of the air cleaner AL, the air may move to the inside of the air cleaner AL through the slit or hole of the rear panel 15.

The rear panel 15 may form an opening or space communicating with the inside of the housing 10 by being spaced from a portion of the housing 10. Air may move to the inside of the housing 10 through the opening or space formed by the rear panel 15.

The slit or hole of the rear panel 15 or the opening or space formed by the rear panel 15 is referred to as an inlet 11S.

Air may move to the inside of the housing 10 through the inlet 11S of the air cleaner AL, and the air moved to the inside of the housing 10 may move to the outside of the housing through the outlet 12S of the air cleaner AL. The inlet 11S and the outlet 12S may be formed in different sides or the same side. The inlet 11S may be formed in a rear end of the housing 10. The outlet 12S may be formed in a front end of the housing 10.

The housing 10 may include a housing cover 13. The housing cover 13 may cover upper, left, and right sides of the housing 10.

The housing cover 13 may define an appearance of the upper, left, and right sides of the housing 10.

The inlet 11S described above may be a space formed between the housing cover 13 and the rear panel 15. The outlet 12S may be a space formed between the housing cover 13 and the front panel 14.

While the air cleaner AL does not operate, the front panel 14 and the rear panel 15 may be in contact with the housing cover 13. Accordingly, the inlet 11S and the outlet 12S may not be formed. While the air cleaner AL operates, at least one portion of the front panel 14 and the rear panel 15 may be spaced from the housing cover 13. Accordingly, the inlet 11S and the outlet 12S may be formed. Accordingly, while the air cleaner AL does not operate, foreign materials may be prevented from entering the inside of the air cleaner AL, and while the air cleaner AL operates, air may enter the inside of the air cleaner AL and be discharged to the outside of the air cleaner AL.

The front panel 14 may increase a size of the outlet 12S by moving in a front direction by a preset length. The front panel 14 may decrease the size of the outlet 12S by moving in the front direction by the preset length and then moving in a rear direction by a preset length.

In other words, the outlet 12S may correspond to a gap between the front panel 14 and the housing 10. As the front panel 14 moves away from the housing 10, the outlet 12S may become greater, and while the front panel 14 moves close to the housing 10, the outlet 12S may become smaller. While the front panel 14 is in contact with the housing 10, the outlet 12S may be closed and air may be discharged to the outside of the air cleaner AL through a plurality of fine outlets 14H formed in the front panel 14. An area of each of the plurality of fine outlets 14H may be smaller than an area of the outlet 12S, and accordingly, air passing through the fine outlets 14H may be discharged at lower speed than air passing through the outlet 12S, although not limited thereto.

However, the front panel 14 may be fixed to the front portion of the housing 100 without moving, and the outlet 12S may be formed in the front panel 14 or the housing 10. The front panel 14 and the housing 10 may be integrated into one body.

The air cleaner AL may be placed on the floor, and in this case, the housing cover 13 may define the appearance of the air cleaner AL together with the front panel 14 and the rear panel 15.

The housing 10 may include a lower panel 16. The lower panel 16 may be positioned in a lower portion of the housing 10. The lower panel 16 may define a lower appearance of the air cleaner AL.

As shown in FIG. 3, the air cleaner AL may include a filter assembly FS. The filter assembly FS may purify air that moves by passing through the filter assembly FS.

The filter assembly FS may be positioned inside the housing 10. The filter assembly FS may be detachably installed in the housing 10.

The filter assembly FS may be configured to pass air therethrough. While air passes through the filter assembly FS, foreign materials included in the air may be adsorbed onto the filter assembly FS.

The air cleaner AL may include a fan assembly FA. The fan assembly FA may operate to move air.

The fan assembly FA may be positioned inside the housing 10. The fan assembly FA may be detachably installed in the housing 10.

The fan assembly FA may cause air to move to the inside of the housing 10 or to the outside of the housing 10. While the fan assembly FA operates, air may flow and upstream and downstream may be defined by the flowing air.

The fan assembly FA may include a fan inlet 100Aa. The fan inlet 100Aa may be an opening which air enters toward the fan assembly FA.

The fan inlet 100Aa may have a circular shape.

The fan assembly FA may have a fan outlet 100Ab. The fan outlet 100Ab may be an opening through which air exits the fan assembly FA.

Air moving toward the fan inlet 100Aa with respect to the fan inlet 100Aa may be defined as upstream, and air moving away from the fan inlet 100Aa with respect to the fan inlet 100Aa may be defined as downstream. Air moving to the fan outlet 100Ab with respect to the fan outlet 100Ab may be defined as upstream, and air moving away from the fan outlet 100Ab with respect to the fan outlet 100Ab may be defined as downstream. However, the disclosure is not limited thereto, and upstream and downstream may be defined as indicating different parts according to a flow of air at a certain location.

The filter assembly FS may be positioned upstream of the fan assembly FA. Accordingly, air taken in through the inlet 11S by the fan assembly FA may pass through the filter assembly FS and move toward the fan assembly FA. The fan assembly FA may move the air toward the outlet 12S.

More specifically, the air may pass through the filter assembly FS and move to inside of the fan assembly FA toward the fan inlet 100Aa of the fan assembly FA, and the air moved to the inside of the fan assembly FA may move toward the outlet 12S of the housing 10 through the fan outlet 100Ab.

The filter assembly FS may be positioned adjacent to the fan assembly FA. The fan assembly FA may cause a flow of air. Because a pressure loss occurs in air passed through the filter assembly FS, the air passed through the filter assembly FS may preferably have a fast flow to move despite the pressure loss. Accordingly, the filter assembly FS may be positioned preferably adjacent to the fan assembly FA.

However, the filter assembly FS may need to be spaced a preset distance from the fan assembly FA. The reason may be because a cross-sectional area of the filter assembly FS in a flow direction of air may be different from a cross-sectional area of the fan inlet 100Aa of the fan assembly FA. According to the cross-sectional area of the filter assembly FS being different from the cross-section area of the fan inlet 100Aa of the fan assembly FA, there may be a case where air needs to circulate rather than move straight toward the fan inlet 100Aa of the fan assembly FA from the filter assembly FS. In this case, in the case in which there is not enough space for air to circulate, the air may move in a turbulent flow rather than a laminar flow. The air moving in the turbulent flow may cause an energy loss due to friction, which may mean that the air does not move smoothly. Smooth movement of air may define an amount of air which the air cleaner AL is capable of filtering over time, and accordingly, it may be needed to prevent air from moving in a turbulent flow.

To this end, the filter assembly FS may be spaced the preset distance from the fan assembly FA. For example, the cross-sectional area of the filter assembly FS may be larger than the cross-sectional area of the fan inlet 100Aa of the fan assembly FA, and the filter assembly FS may be positioned behind the fan assembly FA in such a way as to be spaced from the fan assembly FA.

In the current embodiment, an air guide AG will be additionally described in addition to the characteristic in which the filter assembly FS is spaced from the fan assembly FA.

The air cleaner AL may include the air guide AG. The air guide AG may be a component configured to guide movement of air while the fan assembly FA operates.

The air guide AG may be adjacent to the fan assembly FA.

The air guide AG may include a filter air guide 300 and a fan air guide 300-1.

The filter air guide 300 is also referred to as a first air guide AG. The fan air guide 300-1 is also referred to as a second air guide AG.

The filter air guide 300 may be positioned between the filter assembly FS and the fan assembly FA.

The filter air guide 300 may guide air passed through the filter assembly FS to move to the fan inlet 100Aa of the fan assembly FA.

The air guide AG may include a guide flow path 310P. The guide flow path 310P may be a flow path 10P formed to move air by the air guide AG. The guide flow path 310P may include a first guide flow path 310Pa of the filter air guide 300.

The first air guide flow path 310Pa may penetrate the filter air guide 300. Air passed through the filter assembly FS may pass through the first air guide flow path 310Pa and move toward the fan inlet 100Aa of the fan assembly FA.

A cross-sectional area of a side of the first air guide flow path 310Pa toward the filter assembly FS may be equal or similar to the cross-sectional area of the filter assembly FS. A cross-sectional area of another side of the first air guide flow path 310Pa toward the fan assembly FA may be equal or similar to the cross-sectional area of the fan inlet 100Aa. As shown in FIG. 3, according to the cross-sectional area of the filter assembly FS being larger than the cross-sectional area of the fan inlet 100Aa, the first air guide flow path 310Pa may become gradually narrower toward the fan inlet 100Aa from the filter assembly FS.

The first air guide flow path 310Pa may have a smoothly curved surface to prevent air moving through the first air guide flow path 310Pa from forming a turbulent flow.

The first air guide flow path 310Pa may be positioned in a center area of the filter air guide 300. The first air guide flow path 310Pa may have a shape that is rotationally symmetrical about an axis. The first air guide flow path 310Pa may have a circular cross-section and extend around the axis.

The fan inlet 100Aa may be in a shape of a circle. A center of the circle formed by the fan inlet 100Aa may be identical to the axis of the first air guide flow path 310Pa. The center of the circle formed by the fan inlet 100Aa may be positioned on an axis of rotation of a fan 100. Accordingly, the axis of the first air guide flow path 310Pa may be identical to an axis of rotation of the fan inlet 100A.

The cross section of the first air guide flow path 310Pa toward the fan inlet 100Aa may be in the shape of the circle corresponding to the fan inlet 100Aa. According to a filter 200 having a large cross section, the cross section of the first air guide flow path 310Pa may be a circle having a smaller area toward the fan inlet 100Aa from the filter 200.

That is, in other words, the fan 100 may have the fan inlet 100Aa having a first cross section. The filter 200 may be spaced from the fan 100 and have a second cross section that is larger than the first cross section.

A guide portion 310 may include the guide flow path 310P of which a cross section is reduced toward the fan inlet 100Aa from the filter 200 to prevent air passed through the filter 200 and moving toward the fan inlet 100Aa from generating a turbulent flow while the fan 100 operates.

The filter air guide 300 may be formed of plastic, although not limited thereto.

The filter air guide 300 may be formed by injection molding, although not limited thereto.

The fan air guide 300-1 may be positioned outside the fan assembly FA. The fan air guide 300-1 may be spaced outward in a radial direction from a center of rotation of the fan 100 of the fan assembly FA.

The fan air guide 300-1 may surround at least one portion of the fan assembly FA. The fan air guide 300-1 may include a portion extending from a location adjacent to the outlet of the fan assembly FA toward the outlet 12S of the housing 10 in the fan outlet 100Ab.

For example, the fan air guide 300-1 may have a bell shape. The fan assembly FA may be positioned inside the fan air guide 300-1 having the bell shape. Air moving by the fan air guide 300-1 may move toward an opening having the bell shape along an inner wall of the fan air guide 300-1 having the bell shape.

The fan air guide 300-1 may guide air to move from the fan outlet 100Ab toward the outlet 12S of the housing 10 by the fan assembly FA.

The guide flow path 310P may include a second air guide flow path 310Pb of the fan air guide 300-1. The second air guide flow path 310Pb may penetrate the fan air guide 300-1. Air passed through the fan assembly FA and then passed through the fan outlet 100Ab may move to the outlet 12S of the housing 10 along the second air guide flow path 310Pb.

The second air guide flow path 310Pb may be formed by the fan air guide 300-1 and the fan assembly FA. The fan air guide 300-1 may extend in the front direction. The outlet 12S of the housing 10 may be positioned in the front direction of the filter air guide 300.

The second air guide flow path 310Pb may extend from the fan outlet 100Ab up to a location covered by the filter air guide 300.

Air moved toward the fan assembly FA may pass through the second air guide flow path 310Pb and move toward the outlet 12S of the housing 10.

A cross section of the fan air guide 300-1 may increase gradually toward the outlet 12S of the housing 10. A cross section of the second air guide flow path 310Pb may increase gradually toward the outlet 12S of the housing 10. According to the increase of the cross section of the second air guide flow path 310Pb, air may move at lower speed at a location closer to the outlet 12S of the housing 12S.

The air cleaner AL may have an outlet flow path 12P. The outlet flow path 12P may be the flow path 10P extending from the second air guide flow path 310Pb to the outlet 12S. The outlet flow path 12P may be defined by an edge panel 14a forming an inner wall located inside the housing 10 which will be described below.

Hereinafter, a component which the above-described component may include will be described.

The fan assembly FA may include the fan 100.

The fan 100 may have an axis R of rotation that is parallel to a front-rear direction. The fan 100 may include a hub coupled with a shaft 121, a plurality of blades 110, and a shroud 120 connected to the plurality of blades 110 and forming the fan inlet 100Aa through which air is taken in from behind. The fan inlet 100Aa may open toward the rear direction. The fan inlet 100Aa may be in a shape of a circle. The fan 100 may discharge air toward the front direction. The fan 100 may include a mixed flow fan 100. The fan 100 may include a turbo fan 100.

The fan assembly FA may include a fan motor 130.

The fan motor 130 may provide a driving force to the fan 100 to rotate the blades 110 of the fan 100. The fan motor 130 may include a motor shaft. The motor shaft may extend in the front-rear direction. The motor shaft may be coupled with the fan 100 and transfer power of the fan motor 130 to the fan 100.

The fan motor 130 may be controlled by a controller (not shown). The controller may include a processor and a memory.

The processor may receive a signal through an input device and operate or stop the fan motor 130. Because the blades 110 of the fan 100 rotate by an operation of the fan motor 130, the blades 110 of the fan 100 may rotate by the processor.

That the blades 110 of the fan 110 rotate may mean that the fan 100 operates. An operation of the fan 100 may mean an operation of the fan motor 130. That the fan motor 130 operates may mean that a motor shaft rotates.

The filter assembly FS may include the filter 200. The filter 200 may include a mesh filter 200. The filter 200 may have a plurality of gaps. While air passes through the plurality of gaps, a foreign material included in the air may be filtered.

Another component of the air cleaner AL will be described with reference to FIG. 2.

As shown in FIG. 2, the air cleaner AL may include the front panel 14. The air cleaner AL may include the edge panel 14a positioned behind the front panel 14 to be adjacent to an edge of the front panel 14. The edge panel 14a may extend along a direction in which the edge of the front panel 14 extends.

The air cleaner AL may include the fan assembly FA positioned behind the front panel 14.

The air cleaner AL may include a blow case 101 in which the fan assembly FA is installed. The blow case 101 may form an inner wall of the air cleaner AL.

The air cleaner AL may include the fan air guide 300-1 that is installed in the blow case 101 by moving toward the front direction from behind the blow case 101. The fan air guide 300-1 may be included in the air guide AG. The fan air guide 300-1 may surround the fan 100. As a result of installation of the fan air guide 300-1 in the blow case 101, at least one portion of the fan air guide 300-1 may be positioned in front of the blow case 101.

The air cleaner AL may include a guide case 401 installed in the blow case 101. The guide case 401 may be installed in the blow case 101 by moving toward the blow case 101 from behind the blow case 101.

The air cleaner AL may include the filter air guide 300. The filter air guide 300 may be positioned behind the guide case 401. The filter air guide 300 may be installed in the blow case 101 and the guide case 401.

The air cleaner AL may include a filter case 201 of which at least one portion is positioned between the filter air guide 300 and the filter assembly FS. The filter case 201 may accommodate the filter assembly FS.

The air cleaner AL may include the filter assembly FS installed in the filter case 201.

The air cleaner AL may include the rear panel 15 positioned behind the filter assembly FS.

As shown in FIG. 3, air may move from the inlet 11S toward the outlet 12S. In FIG. 3, the solid arrow indicates the flow of air, and the dotted arrow indicates the flow of sound. A component for reducing noise generated while air moves will be described below.

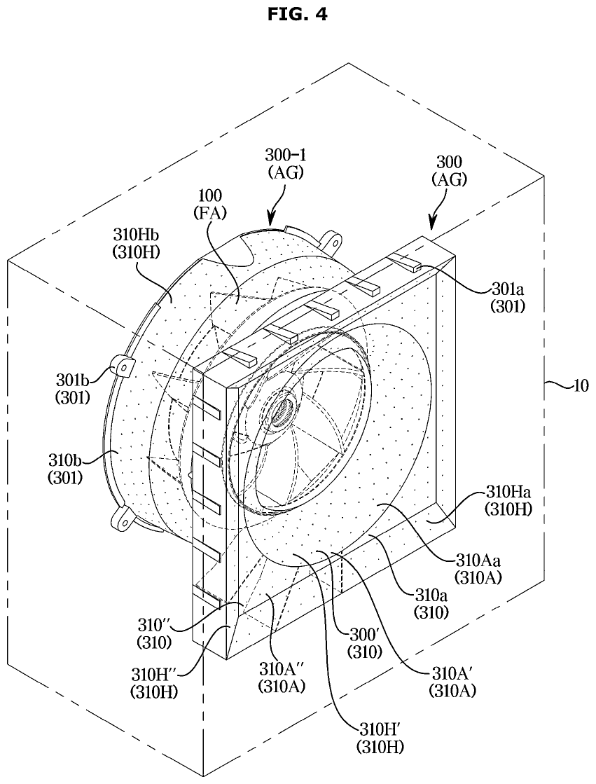

FIG. 4 is a perspective view of a noise reduction apparatus shown in FIG. 3.

The noise reduction apparatus according to an embodiment of the disclosure will be described with reference to FIG. 4.

The air guide AG has been described above. Like the air guide AG described above in an embodiment of the disclosure, an apparatus capable of reducing a sound level is called a noise reduction apparatus. Accordingly, the air cleaner AL may include a noise reduction apparatus. The noise reduction apparatus may include the air guide AG.

Although the noise reduction apparatus according to the disclosure is shown in the drawings and described under an assumption that the noise reduction apparatus is used as a part of the air cleaner AL, the noise reduction apparatus may be not only applied to the air cleaner AL. The noise reduction apparatus may reduce a sound by being positioned adjacent to a component that generates the sound.

In the present document, for convenience of description, the noise reduction apparatus will be described under an assumption that the noise reduction apparatus is a component of the air cleaner AL.

The noise reduction apparatus may be adjacent to the fan 100 or the fan motor 130. The noise reduction apparatus may reduce a sound that is generated in the fan 100 or the fan motor 130.

The fan motor 130 may include a rotor and a stator. Because the rotor rotates relative to the stator, a sound may be generated while the rotor rotates. Furthermore, the fan 100 may be rotated by the motor. While the fan 100 rotates, a sound may be generated due to vibrations generated by the blades 110 coming into contact with air. The noise reduction apparatus may reduce the sound generated in the fan 100 and the fan motor 130.

The noise reduction apparatus may include the air guide AG. The air guide AG may guide air moving by the fan 100. Simultaneously, the air guide AG may reduce a sound level while air flows along the surface of the air guide AG.

The air guide AG may include the guide portion 310 having a guide surface 310A along which air flows. Air may move through the flow path 10P inside the housing 10 along the guide portion 310. The guide portion 310 may form the guide flow path 310P described above.

The guide portion 310 may include a first air guide portion 310a of the filter air guide 300. An opening of the first air guide portion 310a, which is defined by a cross section taken with respect to the axis of rotation of the fan 100, may become narrower toward the fan inlet 100Aa.

The guide surface 310A may include a first air guide surface 310Aa of the filter air guide 300. The first air guide portion 310a may have the first air guide surface 310Aa.

The guide portion 310 may include a second air guide portion 310b of the fan air guide 300-1. An opening of the second air guide portion 310b, which is defined by a cross section taken with respect to the axis of rotation of the fan 100, may become wider toward the outlet 12S of the housing 10.

The guide surface 310A may include a second air guide surface 310Ab of the filter air guide 300. The second air guide portion 310b may have the second air guide surface 310Ab.

In other words, air may move along the guide portion 310. To reduce a sound of the fan 100 that moves air, the air guide AG may include a component which will be described below.

The air guide AG may have a sound absorption hole 310H. The sound absorption hole 310H may penetrate the guide portion 310. The sound absorption hole 310H may extend from the guide surface 310A. The sound absorption hole 310H may extend from the guide surface 310A through the guide portion 310 to the sound insulation space 320S which will be described below. The sound absorption hole 310H may reduce a sound that is generated in the fan 100 or the fan motor 130, together with a sound insulation space 320S which will be described below.

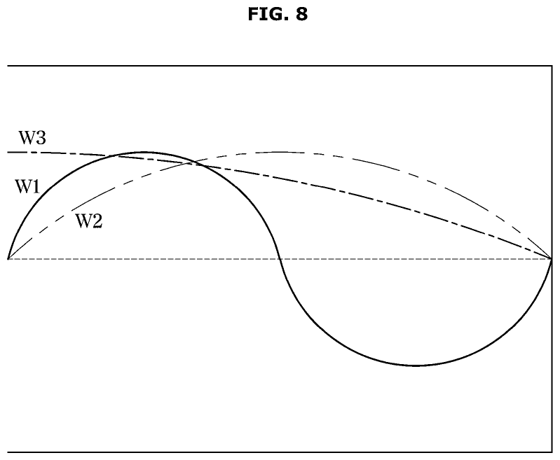

However, although only the sound absorption hole 310H is provided without the sound insulation space 320S, a sound may be reduced. This will be described in detail with reference to FIG. 8.

The sound absorption hole 310H may include a first air guide sound absorption hole 310Ha of the filter air guide 300. The first air guide portion 310a may have the first air guide sound absorption hole 310Ha.

The sound absorption hole 310H may include a second air guide sound absorption hole 310Hb of the fan air guide 300-1. The second air guide portion 310b may have the second air guide sound absorption hole 310Hb.

Referring to FIG. 3, the air guide AG may define the sound insulation space 320S. The guide portion 310 may form the sound insulation space 320S that communicates with the sound absorption hole 310H.

The sound insulation space 320S may include a first air guide sound insulation space 320Sa defined by the first air guide AG.

The sound insulation space 320S may include a second air guide sound insulation space 320Sb defined by the second air guide AG.

The air guide AG may include an air guide installing portion 301 that is installed in a surrounding component.

The air guide installing portion 301 may include a first air guide installing portion 301a of the first air guide AG. The first air guide installing portion 301a may protrude outward from the air guide AG. The first air guide installing portion 301a may extend in a direction in which the first air guide AG is installed. The first air guide installing portion 301a may extend in the front-rear direction. A plurality of first air guide installing portions 301a may be provided.

The air guide installing portion 301 may include a second air guide installing portion 301b of the second air guide AG. The second air guide installing portion 301b may protrude outward from the air guide AG.

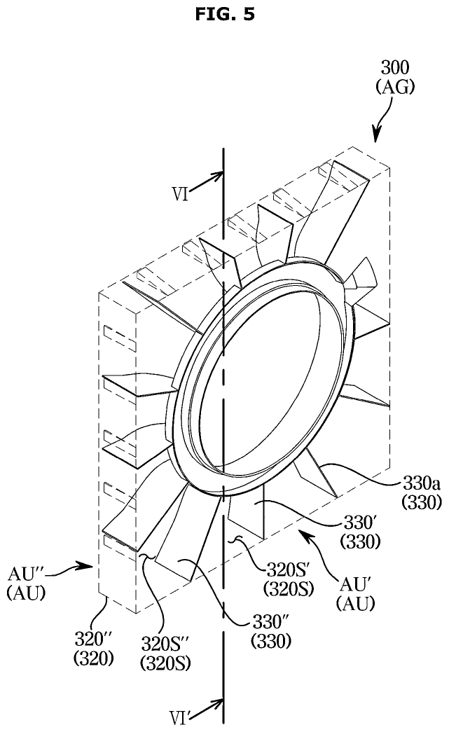

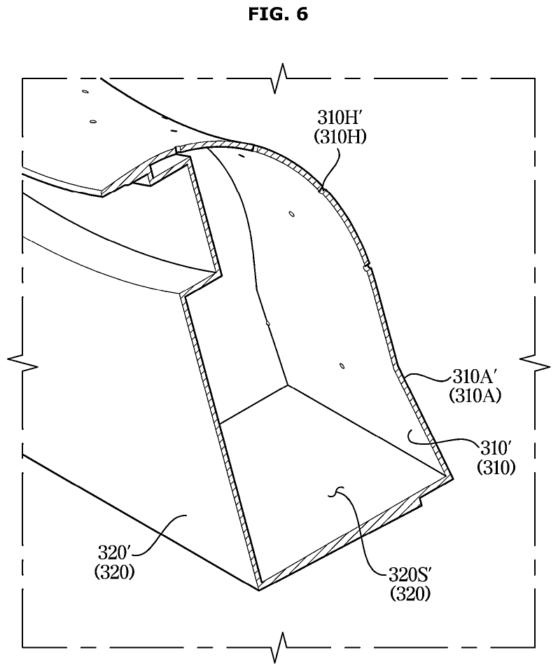

FIG. 5 is a perspective view of the filter air guide 300 shown in FIG. 4. FIG. 6 is an enlarged cross-sectional perspective view resulting from cutting and enlarging the filter air guide 300 shown in FIG. 5.

Referring to FIGS. 5 and 6, a structure of the filter air guide 300 according to an embodiment of the disclosure will be described.

The filter air guide 300 may include the sound insulation space 320S. The first air guide portion 310a of the filter air guide 300 may be expressed as the guide portion 310 of the filter air guide 300. The first air guide flow path 310Pa may be expressed as the guide flow path 310P of the filter air guide 300. The first air guide sound absorption hole 310Ha may be expressed as the sound absorption hole 310H of the filter air guide 300. The first air guide sound insulation space 320Sa may be expressed as the sound insulation space 320S of the filter air guide 300.

The reason why the terms may be replaced with the expressions may be because a concept applied to the filter air guide 300 may also be applied to the fan air guide 300-1. Accordingly, for convenience of expressions, the names of components included in the filter air guide 300 may be replaced with the names of components included in the air guide AG.

The filter air guide 300 may include a space forming portion 320 that defines the sound insulation space 320S. The space forming portion 320 may extend from the guide portion 310 and surround the sound insulation space 320S together with the guide portion 310. The space forming portion 320 may be positioned in the front direction from the guide portion 310. The space forming portion 320 may extend by being bent in the front direction from an edge of the guide portion 310, then be again bent, and extend toward the guide flow path 310P. The space forming portion 320 may extend from the guide portion 310 and define the sound insulation space 320S together with the guide portion 310. The sound insulation space 320S may be defined by the space forming portion 320 and one side of the guide portion 310 which is opposite to the guide surface 310A. However, the sound insulation space 320S may be positioned adjacent to the guide portion 310, as well as at a lower portion of the guide portion 310.

For example, as shown in FIG. 6, in the sound insulation space 320S positioned in a lower side, the space forming portion 320 may extend toward the front direction from the lower portion of the guide portion 310, be bent at an end, and then extend in an up direction.

The filter air guide 300 may include a guide main body 310 and 320. The guide main body 310 and 320 may include the guide portion 310 or the space forming portion 320. The fan air guide 300-1 may include the guide main body 310 and 320. The guide main body 310 and 320 of the fan air guide 300-1 may include the guide portion 310. The air guide AG may include the guide main body 310 and 320.

The space forming portion 320 may form the sound insulation space 320S.

The sound insulation space 320S may communicate with the sound absorption hole 310H. Because the sound insulation space 320S may be adjacent to the guide portion 310, the sound insulation space 320S may be adjacent to the sound absorption hole 310H. The sound insulation space 320S may communicate with the outside of the filter air guide 300 through the sound absorption hole 310H.

A volume of the sound insulation space 320S may be larger than that of the sound absorption hole 310H.

The sound absorption hole 310H and the sound insulation space 320S may reduce a sound level.

A sound is vibration of air. Vibration of air may have properties of waves. That is, a sound may be a sound wave. Accordingly, a sound may have a frequency and wavelength.

The sound absorption hole 310H may define a certain space. The space defined by the sound absorption hole 310H may mean an internal space of the sound absorption hole 310H. Because the sound absorption hole 310H has an empty space, the sound absorption hole 310H may change a resonant frequency of the guide portion 310 or the filter air guide 300.

The resonant frequency of the guide portion 310 or the filter air guide 300 may be defined by formation of the sound absorption hole 310H. Because the sound absorption hole 310H forms an empty space, the sound absorption hole 310H may define the shape of the guide portion 310 or the filter air guide 300.

A sound wave has properties of being absorbed in a component having the same resonant frequency as that of the sound wave. Accordingly, by adjusting a shape, number, diameter, etc. of the sound absorption hole 310H, a sound wave that is to be absorbed in the guide portion 310 or the air guide AG may be targeted. For example, as shown in the drawings, the sound absorption hole 310H may have a cylindrical shape with a circular cross-section. For example, the sound absorption hole 310H may have a prismatic shape with a polygonal cross-section, such as a triangle or a square.

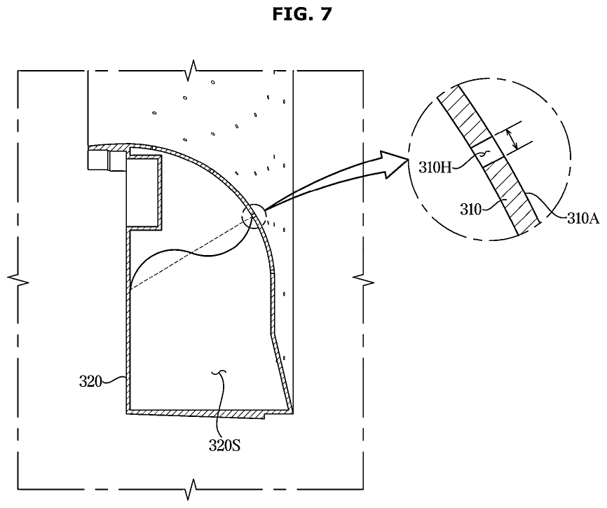

Hereinafter, a principle in which the sound absorption hole 310H absorbs a sound will be described in detail with reference to FIG. 7 or 8.

The principle in which the sound absorption hole 310H absorbs a sound may also be applied to the sound insulation space 320S.

For example, the sound insulation space 320S and the sound absorption hole 310H may correspond to a flask. A narrow inlet of the flask may correspond to the sound absorption hole 310H, and a wide internal space of the flask may correspond to the sound insulation space 320S.

A sound wave entered the sound insulation space 320S through the sound absorption hole 310H may be difficult to escape from the sound insulation space 320S through the sound absorption hole 310H because the sound insulation space 320S has a large volume compared to an entrance diameter of the sound absorption hole 310H.

The smaller the diameter of the sound-absorbing hole 310H, the less the degree to which a sound is emitted to the outside of the air cleaner AL. The reason may be because the sound absorption hole 310H may be an exit through which a sound wave is emitted from the sound insulation space 320S to the outside of the sound insulation space 320S.

The larger the volume of the sound insulation space 320S, the better a sound wave may be accommodated into the sound insulation space 320S. Therefore, the volume of the sound insulation space 320S may set the degree of sound absorption.

It has been described above that the sound absorption hole 310H may define the resonant frequency of the filter air guide 300. The sound insulation space 320S may also define the resonant frequency of the filter air guide 300. The reason may be because the sound insulation space 320S which is an empty space may define the space of the filter air guide 300.

In other words, the sound insulation space 320S may set a frequency of a sound wave to be absorbed in the filter air guide 300. In other words, by adjusting the shape or volume of the sound insulation space 320S, a frequency of a sound wave to be absorbed in the filter air guide 300 may be set.

It may be desirable for the filter air guide 300 to absorb sound waves corresponding to a preset frequency range rather than absorbing only sound waves corresponding to a frequency. The reason may be because sounds generated from the fan 100 or the motor may have various frequencies.

Hereinafter, a principle in which the sound insulation space 320S absorbs a sound will be described in detail with reference to FIG. 7 or 8.

As described above, the sound absorption hole 310H and the sound insulation space 320S may reduce a sound level.

According to the air guide AG having a single resonant frequency, the air guide AG may absorb a sound of a single frequency. For the air guide AG to absorb sounds of various frequencies, the air guide AG may have various resonant frequencies. To this end, the filter air guide 300 may include a sound insulation unit AU. A plurality of sound insulation units AU may be provided.

In this case, a frequency of a sound wave absorbed in the filter air guide 300 may be preferably within audible frequencies. The audible frequencies broadly consist of less than 20,000 Hz, and are most audible to humans in the range of 500 Hz to 4000 Hz. Accordingly, it may be desirable that a frequency of a sound absorbed in the filter air guide 300 includes a frequency between 500 Hz and 4000 Hz. Therefore, it is desirable that the resonant frequency of the plurality of sound insulation units AU is between 500 Hz and 4000 Hz.

The plurality of sound insulating units AU may include a first sound insulation unit AU′ and a second sound insulation unit AU″ having a different resonant frequency from the first sound insulating unit AU′.

Each of the plurality of sound insulation units AU may have a corresponding sound insulation space 320S.

The sound insulation space 320S may include a first sound insulation space 320S and a second sound insulation space 320S. The first sound insulation space 320S may be a space corresponding to the first sound insulation unit AU′. The second sound insulating unit AU″ may be a sound insulating space 320S corresponding to the second sound insulating space 320S.

To form the plurality of sound insulation units AU, the filter air guide 300 may include a separating partition 330.

The separating partition 330 may extend from the guide portion 310 to the space forming portion 320. The separating partition 330 may extend vertically or horizontally within the sound insulation space 320S.

The separating partition 330 may separate the plurality of sound insulation spaces 320S independently.

A plurality of separating partitions 330 may be provided.

The plurality of separating partitions 330 may be arranged with a pattern. The plurality of separating partitions 330 may be arranged in a circumferential direction based on a center of the guide passage 310P. The plurality of separating partitions 330 may be arranged at regular intervals and the shape of the filter air guide 300 may be approximately a rectangular parallelepiped. In this case, a sound insulation space 320S corresponding to a corner portion and a sound insulation space 320S corresponding to an edge portion may be defined with different volumes.

The plurality of separating partitions 330 may include a first separating partition 330′ and a second separating partition 330″ spaced apart from the first separating partition 330′.

The sound insulation space 320S may be defined by the guide portion 310 and the space forming portion 320. The guide portion 310 and the space forming portion 320 may be provided to correspond to the first sound insulation space 320S and the second sound insulation space 320S, respectively.

The guide portion 310 may include a first guide portion 310′ that defines the first sound insulating space 320S and a second guide portion 310″ that defines the second sound insulating space 320S.

The space forming portion 320 may include a first space forming portion 320′ that defines the first sound insulating space 320S and a second space forming portion 320″ that defines the second sound insulating space 320S.

The first sound insulation space 320S may be surrounded by the first guide portion 310′, the first space forming portion 320′, and the separation partition 330. The second sound insulation space 320S may be surrounded by the second guide portion 310″, the second space forming portion 320″, and the separating partition 330.

The first sound insulation space 320S and the second sound insulation space 320S may be provided independently. The first sound insulation space 320S may be located adjacent to the second sound insulation space 320S. According to the first sound insulating space 320S being located adjacent to the second sound insulating space 320S, the separating partition 330 may be located between the first sound insulating space 320S and the second sound insulating space 320S. In this case, the first sound insulation space 320S may be defined by being surrounded by the separating partition 330 located between the first sound insulation space 320S and the second sound insulation space 320S, another separating partition 330, the first guide portion 310′, and the first space forming portion 320′.

The sound absorption hole 310H may include a first sound absorption hole 310H′ corresponding to the first sound insulation space 320S and a second sound absorption hole 310H″ corresponding to the second sound insulation space 320S. Because the first sound insulation space 320S is defined by the first guide portion 310′, the first sound absorption hole 310H′ may be included in the first guide portion 310′. Because the second sound insulation space 320S is defined by the second guide portion 310″, the second sound absorption hole 310H″ may be included in the second guide portion 310″.

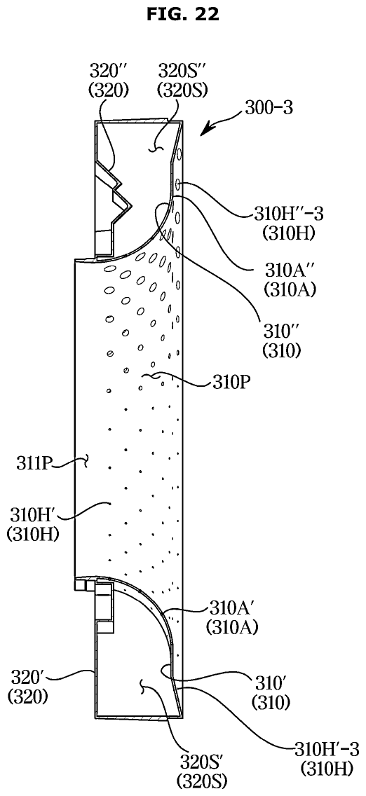

A diameter of the first sound absorption hole 310H′ may be different from a diameter of the second sound absorption hole 310H″ such that the first sound insulation unit AU′ has a different resonant frequency from the second sound insulation unit AU″. This will be described in more detail with reference to FIG. 22.

A volume of the first sound absorption hole 310H′ may be different from a volume of the second sound absorption hole 310H″ such that the first sound insulation unit AU′ has a different resonant frequency from the second sound insulation unit AU″.

A plurality of sound absorption holes 310H may be provided. Accordingly, a plurality of first sound absorption holes 310H′ or a plurality of second sound absorption holes 310H″ may be provided.

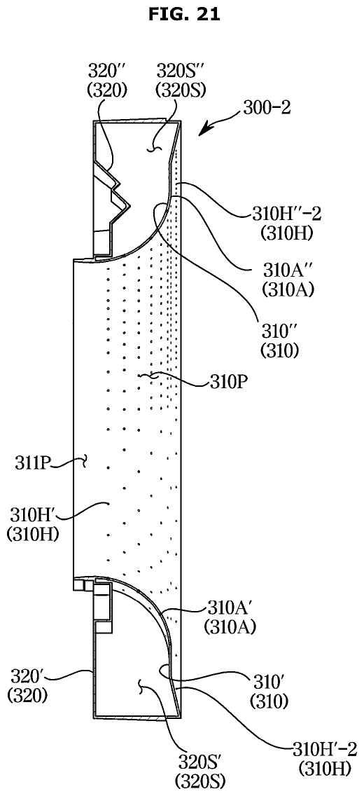

The number of the plurality of first sound absorption holes 310H′ may be more than the number of the plurality of second sound absorption hole 310H″ such that the first sound insulation unit AU′ has a different resonant frequency from the second sound insulation unit AU″. In other words, the number of the plurality of first sound absorption hole 310H′ for a volume of the first sound insulation space 320S may be different from the number of the plurality of second sound absorption holes 310H″ for a volume of the second sound insulation space 320S such that the resonant frequency of the first sound insulation unit AU′ is different from the resonant frequency of the second sound insulation unit AU″. This will be described in more detail with reference to FIG. 21.

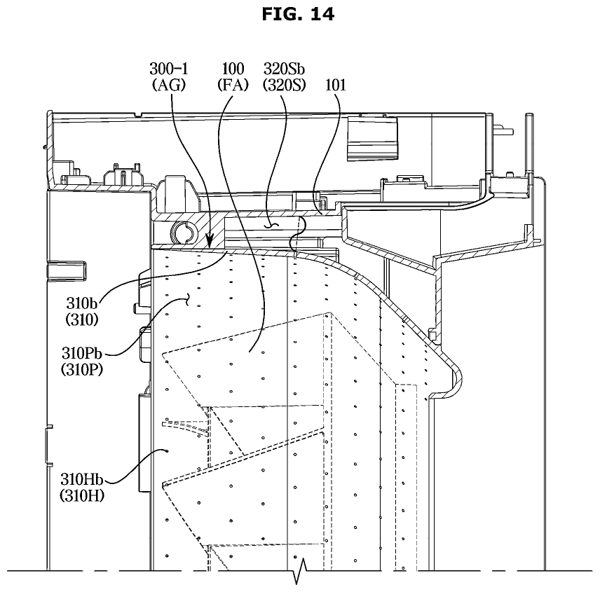

Each of the sound absorption holes 310H may have a preset diameter. Because the filter air guide 300 reduces a sound in an environment where air flows by the fan 100 without simply reducing only the sound level, generation of sound by the flow of air may need to be prevented. To this end, the diameter of the sound absorption hole 310H may be limited. This will be described in detail with reference to FIGS. 14 to 17.

The sound absorption hole 310H may penetrate the guide portion 310 vertically to prevent a distance between two points on the opening of the sound absorption hole 310H from exceeding a preset value. The preset value may be 2.0 mm. However, for process reasons, a part of the sound absorption holes 310H may penetrate the guide portion 310 vertically, whereas another part of the sound absorption holes 310H may penetrate the guide portion 310 in a direction that intersects a direction perpendicular to the guide portion 310. In other words, at least one part of the sound absorption holes 310H may penetrate the guide portion 310 vertically.

The above descriptions have been given under an assumption of application to the filter air guide 300. However, the same principle may also be applied to the fan air guide 300-1. In other words, the above descriptions may be applied to the air guide AG.

FIG. 7 is an enlarged cross-sectional view resulting from cutting and enlarging the filter air guide 300 shown in FIG. 5. FIG. 8 is a conceptual diagram conceptually showing a principle of absorbing a sound in the filter air guide 300 shown in FIG. 7.

A principle of reducing a sound level, according to an embodiment of the disclosure, will be described with reference to FIGS. 7 and 8.

A noise reduction effect by the filter air guide 300 according to an embodiment of the disclosure will be described with reference to FIGS. 7 and 8.

As shown in FIG. 8, a pipe of which one end is closed and another end is opened may be assumed.

A case in which a sound wave W1 is propagated through the pipe is assumed. Because a sound wave is vibration of air, the sound wave may have a wavelength and frequency.

For the sound wave W1 to be absorbed in the pipe, an end of the wavelength of the sound wave W1 may need to be positioned at the closed end of the pipe. According to the end of the wavelength of the sound wave W1 being positioned at the closed end of the pipe, the sound wave W1 may be difficult to be transferred in the traveling direction because no medium is provided at the closed end of the pipe. Furthermore, this phenomenon may occur in the case in which a start part of a wave is located at the open end of the pipe. In other words, this phenomenon may occur according to nodes of a wavelength being located at the open and closed ends of the pipe.

That is, according to a length of a wavelength being identical to a length of the pipe, the wavelength having the corresponding length may be absorbed in the pipe. Energy of the sound wave W1 may be converted into heat energy while being absorbed in the pipe.

A sound wave having a certain wavelength may be considered to have a certain frequency because a sound has constant speed in air. Accordingly, the pipe may absorb a sound wave of a certain frequency according to the length. This may be expressed that according to a resonant frequency of a pipe being identical to a frequency of a sound wave, the pipe absorbs the sound wave of the corresponding frequency.

However, according to the sound wave W1 having a too long wavelength, the pipe may need to have a too long length to absorb the sound wave W1. This may mean that the size of a product may become too larger to design the length of the pipe required to absorb the sound wave W1. Accordingly, the length of the pipe may need to be reduced.

It is assumed that there is a sound wave W2 with a wavelength that is twice the wavelength of the sound wave W1 used as an example.

Nodes of the corresponding sound wave W2 may be respectively positioned at the open and closed ends of the pipe. Inside the pipe, a part corresponding to the half wavelength of the sound wave W2 may be located. Even in this case, the sound wave W2 may be absorbed in the pipe, as in the case where one wavelength is located inside the pipe.

Furthermore, it is assumed that there is a sound wave W3 having a wavelength that is twice the wavelength of the sound wave W2.

In the case in which a node of the sound wave W3 is located at the closed end of the pipe and a ridge or valley of the sound wave W3 is located at the open end of the pipe, the sound wave W3 may be absorbed in the pipe, as in the case where one wavelength is located inside the pipe.

As in the last example, although a pipe having a length corresponding to ¼ of a wavelength of a sound wave is provided, the sound wave may be absorbed in the pipe. Accordingly, the length of the pipe required to absorb a sound may be reduced.

As described above, a sound wave having a wavelength of which the ridge, valley, or node is located at the open end of the pipe may be absorbed in the pipe. To locate a major part of wavelengths of sound waves generated by a sound at the open end of the pipe, it may be desirable that a plurality of pipes are provided.

As shown in FIG. 7, a plurality of sound absorption holes 310H may be provided. The reason may be to absorb a large amount of sound waves through the sound absorption holes 310H.

The plurality of sound absorption holes 310H may be distributed uniformly in the air guide AG, as shown in FIG. 4. The reason may be to stably absorb sound waves located at any portion of the air guide AG.

As shown in FIG. 7, the sound insulation space 320S may be a component corresponding to the pipe described above.

A sound wave passed through the sound absorption hole 310H may move to the sound insulation space 320S and be absorbed in a portion of the air guide AG having a frequency corresponding to a frequency of the sound wave.

In this case, the absorbed sound wave may be affected by a diameter of the sound absorption hole 310H, a thickness of the guide portion 310, a depth of the sound absorption hole 310H, and porosity (a ratio of a total area of the sound absorption holes 310H with respect to an area of the guide portion 310). As the sound absorption holes 310H have a smaller diameter, the guide portion 310 has a greater thickness, the sound absorption holes 310H have a greater depth, and porosity is smaller, it may be difficult for sound waves to escape from the sound insulation space 320S through the sound absorption holes 310H, and accordingly, a sound may be better absorbed. In another aspect, as the sound absorption holes 310H have a smaller diameter, the guide portion 310 has a greater thickness, the sound absorption holes 310H have a greater depth, and porosity is smaller, sound waves having longer wavelengths and smaller frequencies may be absorbed.

This principle may be applied to all embodiments described in the disclosure and all cases to which the concept of the disclosure is applied.

The plurality of sound insulation units AU may have different resonant frequencies. For the plurality of sound insulation units AU to have different resonant frequencies, the plurality of sound insulation units AU may be designed to have different frequencies by adjusting the above-mentioned variables.

Furthermore, according to the above-described principle, a too large sound insulation space 320S may be required to absorb sound waves of a required frequency.

For example, a length corresponding to a ¼ wavelength of a sound wave of 1000 Hz, which belong to an audible range among audible frequencies, may be 85 mm. To embody the sound insulation space 320S having a length of 85 mm in the air cleaner AL, the air cleaner AL having a large size may be required.

However, according to the noise reduction apparatus configured with the sound absorption holes 310H and the sound insulation space 320S, as in an embodiment of the disclosure, a sound wave of a target frequency may be absorbed with only a width of 1/10 of the wavelength.

In the noise reduction apparatus configured with the sound absorption holes 310H and the sound insulation space 320S, a density value of air at a portion being adjacent to the sound absorption holes 310H may be calculated as a negative number. In this way, a structure that produces results different from common physical knowledge is called a meta-structure. The air guide AG may have a meta-structure.

The air guide AG, which is a meta-structure, having the sound absorption holes 310H and the sound insulation space 320S may form an air guide AG having a resonant frequency corresponding to a frequency of 1000 Hz although the air guide AG does not have the length of 85 mm. In other words, the air guide AG may include the sound insulation space 320S having a length of 1/10 of a wavelength corresponding to a low frequency region to reduce a sound of the low frequency region.

In addition, the above descriptions based on the sound having the frequency band of 1000 Hz may also be applied in the similar way to regions of 1000 Hz or more and regions of 1000 Hz or less. That is, to prevent users from feeling uncomfortable due to noise, it may be needed to reduce sounds of all frequency bands. Accordingly, the above-described concept about the sound absorption holes 310H and the sound insulation space 320S may be used to reduce a sound corresponding to an arbitrary frequency.

The noise reduction apparatus may need to reduce noise around a noise source, and also need to have an effect of reducing noise in an environment where air flows. This will be described below.

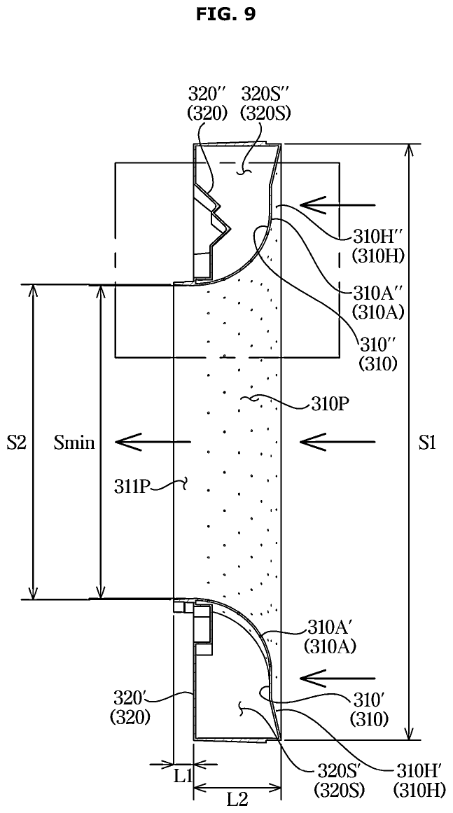

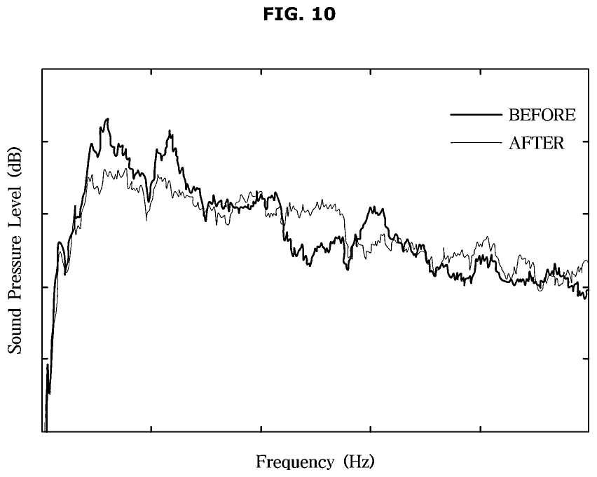

FIG. 9 is a cross-sectional view showing a flow of air through the filter air guide 300 shown in FIG. 5. FIG. 10 is a graph showing a noise reduction effect by the filter air guide 300 shown in FIG. 9.

An effect of the air guide AG according to an embodiment of the disclosure will be described with reference to FIGS. 9 and 10.

As shown in FIG. 9, the air guide AG which is provided with the plurality of sound-absorbing holes 310H to correspond to the sound insulation units AU is called a microporous panel-type noise reduction apparatus. The filter air guide 300 is called a microporous panel-type noise reduction apparatus. Furthermore, the fan air guide 300-1 described above with reference to FIG. 14 is also called a microporous panel-type noise reduction apparatus.

After the filter air guide 300 shown in FIG. 9 is installed in the air cleaner AL and the fan 100 operates, an experiment has been conducted to measure how much a sound level is reduced.

In the experiment, flow velocities of air have been designed to be 1 m/s immediately after the air passes through the filter 200, 10 m/s at the fan inlet 100Aa, and 15 m/s at the fan outlet 100Ab. Results of the experiment are shown in FIG. 10.

The X axis of a graph shown in FIG. 10 represents frequency, and the Y axis of the graph represents sound level. The X axis represents 500 Hz per one unit, and the Y axis represents 10 dB per one unit.

Comparing after the filter air guide 300 is installed to before the filter air guide 300 is installed, it is seen that the graph of after the filter air guide 300 is installed shows a sound level reduction effect of about 3 dB. That is, the filter air guide 300 may have a noise reduction effect.

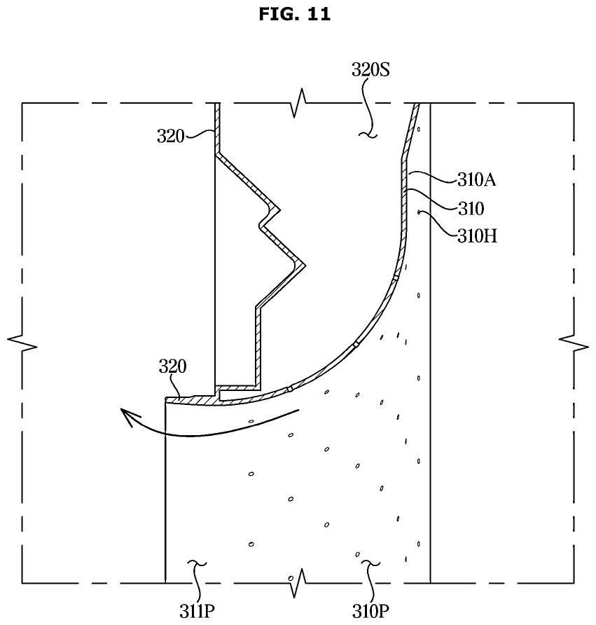

FIG. 11 is an enlarged cross-sectional view of a portion of the filter air guide shown in FIG. 9.

A flow induction flow path 311P in the shape of the filter air guide 300 according to an embodiment of the disclosure will be described with reference to FIG. 11.

As shown in FIG. 9, a diameter of an opening positioned in a front area of the guide flow path 310P of the filter air guide 300 is S2, and a diameter of an opening positioned in a rear area of the guide flow path 310P is S1.

Also, a diameter of a smallest cross-sectional area in the guide flow path 310P is Smin. Smin may have a length of 90% or more of S1 or S2.

A portion extending from a location defining Smin to a location defining S2 may be expressed as a flow induction portion 320. The filter air guide 300 may include the flow induction portion 320. The flow induction portion 320 may define the flow induction flow path 311P.

The flow induction flow path 311P may have a greater cross-sectional area toward the front direction. The flow induction flow path 311P may have a greater cross-sectional area toward the fan inlet 100Aa.

The flow induction portion 320 may extend from the guide portion 310. The flow induction portion 320 may extend from the guide portion 310 toward the fan inlet 100Aa. The flow induction portion 320 may be inclined toward the fan inlet 100Aa with respect to the guide portion 310.

For example, in the cross-sectional view as shown in FIG. 11, an end of the flow induction portion 320 may extend toward an upper direction. The flow induction flow path 311P formed by the flow induction portion 320 may function as a diffuser. The guide flow path 310P may function to collect air, like a nozzle, and the flow induction flow path 311P may function to diffuse air, like a diffuser.

The flow induction flow path 311P may have a flow induction surface along which air flows. While air flows along the flow induction surface, the air may move along a direction in which the shroud 120 (see FIG. 3) of the fan 100 extends. The shroud 120 of the fan 100 may extend while being inclined away from the axis of rotation of the fan 100 toward the front direction such that air flows smoothly by the blades 110 (see FIG. 3).

Accordingly, because the flow induction flow path 311P is inclined, the flow induction flow path 311P may cause air to move in an extension direction of the fan guide flow path 100P formed by the shroud 120 of the fan 100.

In other words, the fan 100 may include the shroud 120 which is positioned between the blades 110 and the air guide AG and extends radially from the center of rotation of the blades 110 along the axis of rotation of the blades 110. The air guide AG may include the flow induction flow path 311P of which a cross-sectional area increases gradually toward the shroud 120 from an end of the guide flow path 310P such that according to an operation of the fan 100, air moves in the extension direction of the shroud 120 while air moves.

Because the length of Smin, mentioned above, is 90% or more of the length of S1 or S2, occurrence of turbulence may be prevented while air moves. A sharp change of the flow path 10P may cause turbulence in a flow. Because the length of Smin has a preset value, air may be prevented from becoming turbulent.

Preferably, in the case in which the length of S1 is 6.8 times of the length in front-rear direction of the guide portion 310, the length of S2 is 15.80 times of the length in front-rear direction of the flow induction portion 320, and the length of Smin is 0.99 times of the length of S2, the occurrence of turbulence may be prevented.

By including the filter air guide 300 having the dimensions, the experiment designed such that flow velocities of air are 1 m/s immediately after the air passes through the filter 200, 10 m/s at the fan inlet 100Aa, and 15 m/s at the fan outlet 100Ab has showed that no loss has occurred at the flow velocities of air.

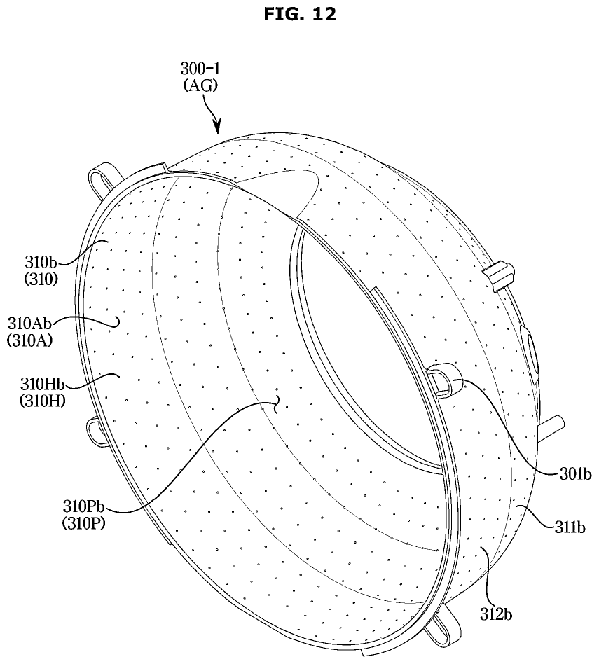

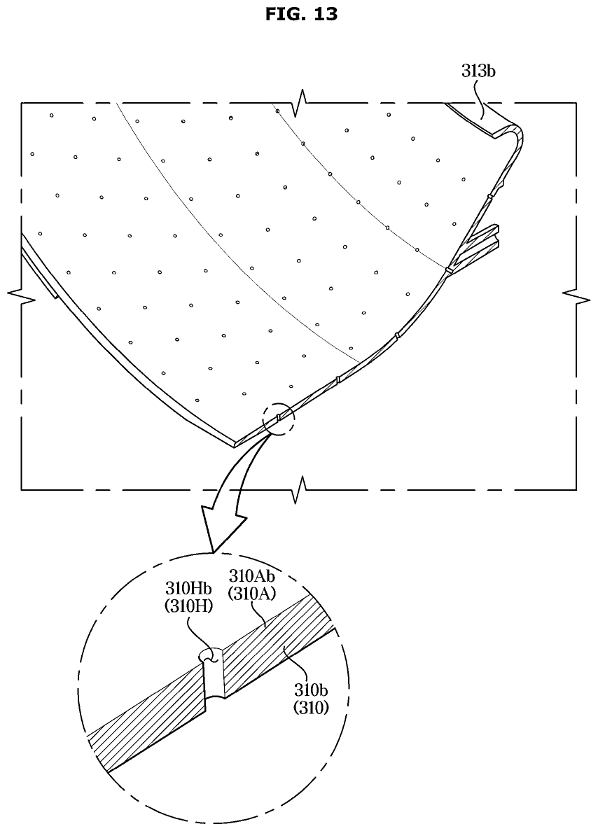

FIG. 12 is a perspective view of the fan air guide 300-1 shown in FIG. 4. FIG. 13 is an enlarged cross-sectional perspective view resulting from cutting and enlarging the fan air guide 300-1 shown in FIG. 12.

A structure of the fan air guide 300-1 according to an embodiment of the disclosure will be described with reference to FIGS. 12 and 13.

The above descriptions about the filter air guide 300 may also be applied to the fan air guide 300-1. Hereinafter, the fan air guide 300-1 will be described in detail.

The fan air guide 300-1 may define the sound insulation space 320S. The second air guide portion 310b of the fan air guide 300-1 may be expressed as the guide portion 310 of the fan air guide 300-1. The second air guide flow path 310Pb may be expressed as the guide flow path 310P of the fan air guide 300-1. The second air guide absorption hole 310Hb may be expressed as the sound absorption hole 310H of the fan air guide 300-1. The second air guide sound insulation space 320Sb may be expressed as the sound insulation space 320S of the fan air guide 300-1.

Particularly, as shown in FIG. 14, the sound insulation space 320S may be defined by the housing 10. The sound insulation space 320S may be defined by the blow case 101 (see FIG. 3). The housing 10 or the blow case 101 may be adjacent to the fan air guide 300-1, and in this case, a space formed between the housing 10 or the blow case 101 and the fan air guide 300-1 may be the sound insulation space 320S.

The housing 10 or the blow case 101 may surround the sound insulation space 320S together with the guide portion 310 of the fan air guide 300-1.

The sound insulation space 320S may communicate with the sound absorption hole 310H. Because the sound insulation space 320S may be adjacent to the guide portion 310, the sound insulation space 320S may be adjacent to the sound absorption hole 310H. The sound insulation space 320S may communicate with the outside of the fan air guide 300-1 through the sound absorption hole 310H.

The volume of the sound insulation space 320S may be larger than that of the sound absorption hole 310H.

A sound level may be reduced by the sound absorption hole 310H and the sound insulation space 320S.

A sound wave entered the sound insulation space 320S through the sound absorption hole 310H may be difficult to escape from the sound insulation space 320S through the sound absorption hole 310H because the sound insulation space 320S has a large volume compared to the entrance diameter of the sound absorption hole 310H.

The smaller the diameter of the sound-absorbing hole 310H, the smaller the degree to which a sound is emitted to the outside of the air cleaner AL. The reason may be because the sound absorption hole 310H may be an exit through which a sound wave is emitted from the sound insulation space 320S to the outside of the sound insulation space 320S.

The larger the volume of the sound insulation space 320S, the better sound waves may be accommodated into the sound insulation space 320S. Therefore, the volume of the sound insulation space 320S may set the degree of sound absorption.

As described above, the sound absorption hole 310H may define the resonant frequency of the fan air guide 300-1. The sound insulation space 320S may also define the resonant frequency of the fan air guide 300-1. The reason may be because the sound insulation space 320S which is an empty space may define the shape of the filter air guide 300.

That is, the sound insulation space 320S may set a frequency of a sound wave to be absorbed in the fan air guide 300-1. In other words, by adjusting the shape or volume of the sound insulation space 320S, a frequency of a sound wave to be absorbed in the filter air guide 300 may be set. In other words, by adjusting the shape or volume of the sound insulation space 320S, a frequency of a sound wave to be absorbed in the fan air guide 300-1 may be set.

It may be desirable for the fan air guide 300-1 to absorb sound waves corresponding to a preset frequency range rather than absorbing only sound waves corresponding to a frequency. The reason may be because sounds generated from the fan 100 or the motor may have various frequencies.

In this way, the sound absorption hole 310H and the sound insulation space 320S may reduce a sound level.

The air guide AG having a single resonant frequency may absorb a sound having a single frequency. For the air guide AG to absorb sounds of various frequencies, the air guide AG may have various resonant frequencies. To this end, the fan air guide 300-1 may include the sound insulation unit AU. A plurality of sound insulation units AU may be provided.

In this case, a frequency of a sound wave absorbed in the fan air guide 300-1 may be preferably within audible frequencies. The audible frequencies broadly consist of less than 20,000 Hz, and are most audible to humans in the range of 500 Hz to 4000 Hz. Accordingly, it is desirable that a frequency of a sound absorbed in the fan air guide 300-1 includes a frequency between 500 Hz and 4000 Hz. Therefore, it may be desirable that a resonant frequency of the plurality of sound insulation units AU is between 500 Hz and 4000 Hz.

The plurality of sound insulating units AU may include the first sound insulating unit AU′ and the second sound insulating unit AU″ having a different resonant frequency from the first sound insulating unit AU′. Although a separating partition 330 that separates the plurality of sound insulation spaces 320S is not shown in the drawings, the fan air guide 300-1 according to an embodiment of the disclosure may also include the separating partition 300. Accordingly, the fan air guide 300-1 may define the first sound insulation space 320S and the second sound insulation space 320S defined by the separating partition 330. The guide portion 310 may include a first guide portion 310′ that defines the first sound insulation space 320S and a second guide portion 310″ that defines the second sound insulation space 320S. The sound absorption hole 310H may include a first sound absorption hole 310H′ corresponding to the first sound insulation space 320S and a second sound absorption hole 310H″ corresponding to the second sound insulation space 320S. A plurality of sound absorption holes 310H may be provided. Accordingly, a plurality of first sound absorption holes 310H′ or a plurality of second sound absorption holes 310H″ may be provided. The number of the plurality of first sound absorption holes 310H′ may be more than the number of the plurality of second sound absorption holes 310H″ such that the first sound insulation unit AU′ has a different resonant frequency from the second sound insulation unit AU″.

The fan air guide 300-1 may include a guide inlet 313b. The guide inlet 313b may be adjacent to the fan inlet 100Aa. The guide inlet 313b may be an opening of the fan air guide 300-1. Air may move through the guide inlet 313b.

The guide inlet 313b may extend toward the front direction from the guide portion 310.

The fan air guide 300-1 may include a diffuser 311b. The diffuser 311b may extend toward the front direction from the guide inlet 313b. The diffuser 311b may extend to correspond to the shroud 120.

The diffuser 311b may form a circular opening. A cross section of the diffuser 311b, taken along an axial direction, may increase toward the front direction.

The fan air guide 300-1 may include an induction portion 312b. The induction portion 312b may extend toward the front direction from the diffuser 311b. The induction portion 312b may form a circular opening. A cross section of the induction portion 312b, taken along the axial direction of the induction portion 312b may increase toward the front direction. A change rate in area of the cross section of the induction portion 312b may be less than a change rate in area of the cross section of the diffuser 311b.

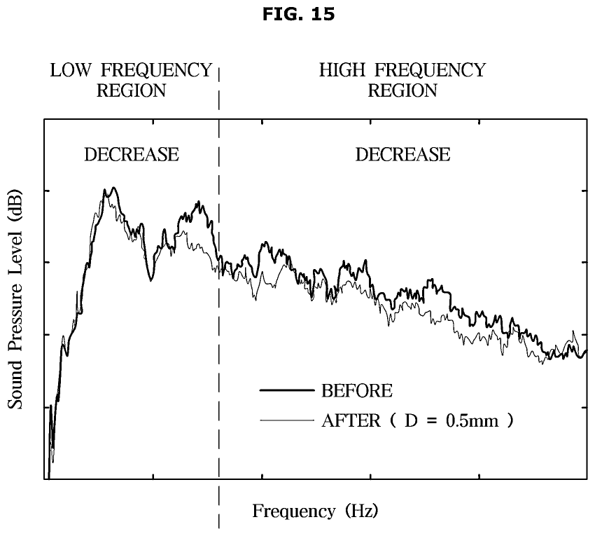

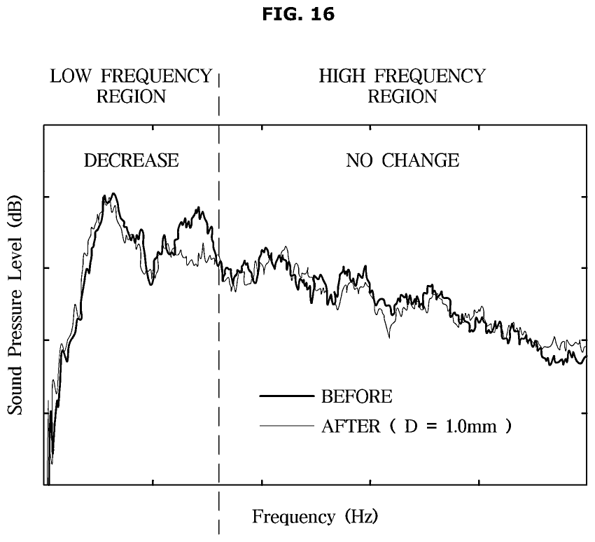

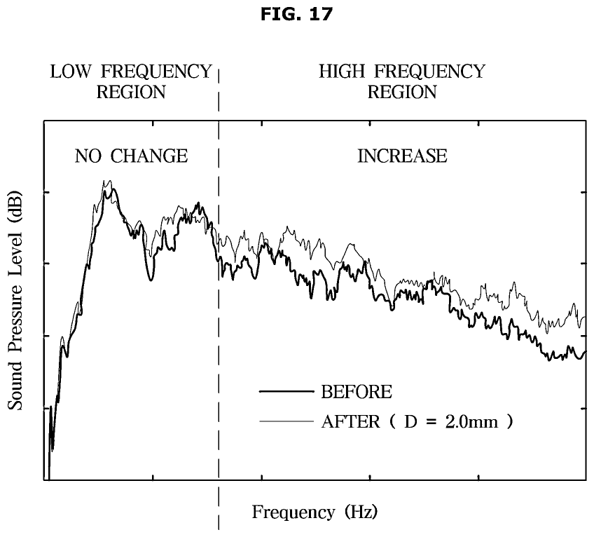

FIG. 14 is a cross-sectional view showing the fan air guide 300-1 shown in FIG. 12 and a component for reducing noise together. FIG. 15 is a graph showing a sound absorption effect by the fan air guide 300-1 shown in FIG. 14, which includes the sound absorption hole 310H having a diameter of 0.5 mm. FIG. 16 is a graph showing a sound absorption effect by the fan air guide 300-1 shown in FIG. 14, which includes the sound absorption hole 310H having a diameter of 1.0 mm. FIG. 17 is a graph showing a sound absorption effect by the fan air guide 300-1 shown in FIG. 14, which includes the sound absorption hole 310H having a diameter of 2.0 mm.

An appropriate diameter of the sound absorption hole 310H of the fan air guide 300-1 according to an embodiment of the disclosure will be described with reference to FIGS. 14 to 17.

The fan air guide 300-1 may surround the fan 100 to form the guide flow path 310P. In other words, the air guide AG may be spaced outward in a radial direction from the center of rotation of the fan 100 and extend in the circumferential direction, and the sound insulation space 320S may be positioned between the air guide AG and the housing 10.

FIGS. 15 to 17 are graphs showing a noise reduction effect according to a diameter change of the sound absorption hole 310H included in the fan air guide 300-1.

After the fan air guide 300-1 is installed as shown in FIG. 14, an experiment has been conducted. In the experiment, flow velocities of air have been designed to be 1 m/s immediately after the air passes through the filter 200, 10 m/s at the fan inlet 100Aa, and 15 m/s at the fan outlet 100Ab. The X axis of the shown graphs represents frequency, and the Y axis of the graphs represents sound level. The X axis represents 500 Hz per one unit, and the Y axis represents 10 dB per one unit.

As shown in FIG. 15, according to the diameter D of the sound absorption hole 310H being 0.5 mm, in the case in which the fan air guide 300-1 is installed, noise has been reduced in a low frequency region and a high frequency region compared to the case in which the fan air guide 300-1 is not installed.

As shown in FIG. 16, according to the diameter D of the sound absorption hole 310H being 1.0 mm, in the case in which the fan air guide 300-1 is installed, noise has been reduced in the low frequency region and no noise reduction has occurred in the high frequency region compared to the case in which the fan air guide 300-1 is not installed. There was no significant difference in noise in the high frequency region between the case in which the air guide AG is installed and the case in which the air guide AG is not installed.

As shown in FIG. 17, according to the diameter D of the sound absorption hole 310H being 2.0 mm, in the case in which the fan air guide 300-1 is installed, noise has not been reduced in the low frequency region and noise has even increased in the high frequency region compared to the case in which the fan air guide 300-1 is not installed.

The reason may be because, although noise generated in the fan 100 or the fan motor 130 is reduced by the sound absorption hole 310H and the sound insulation space 320S, a flow of air may generate a sound. While air flows, the air may also have a resonant frequency. In this case, according to the resonant frequency of the flowing air being identical to the resonant frequency of the fan air guide 300-1, resonance may occur. As a result of resonance, an amplitude of a sound may increase.

That is, a component for reducing noise according to a flow of air may need to suppress the generation of sound due to the flow of air, in addition to simply reducing noise. To prevent air from resonating with the air guide AG, the diameter of the sound absorption hole 310H may be 2.0 mm or less. Preferably, the diameter of the sound absorption hole 310H may be 0.5 mm or less.

Particularly, the diameter of the sound absorption hole 310H has seemed to have a critical effect in a low frequency region of 1000 Hz or less. The region below 1000 Hz is within the human's audible frequency region and is also a frequency region in which humans hear best.

By providing the sound absorption hole 310H having a preset diameter, noise may be reduced even in a frequency region above 1000 Hz. Accordingly, the sound absorption hole 310H may reduce a sound level in the low frequency region of 1000 Hz or less and the high frequency region above 1000 Hz. By reducing sounds in a preset frequency region, a user's discomfort caused by noise may be reduced.

The results of the experiment may be applied in the same way to the filter air guide 300, as well as the fan air guide 300-1.

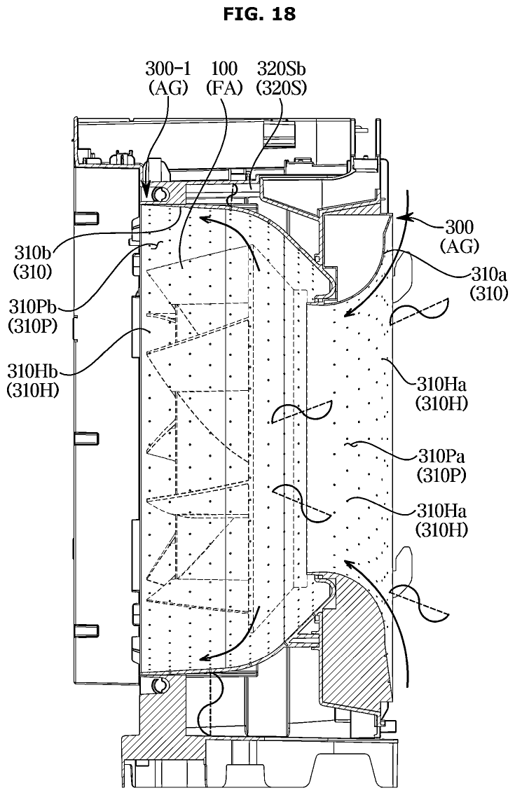

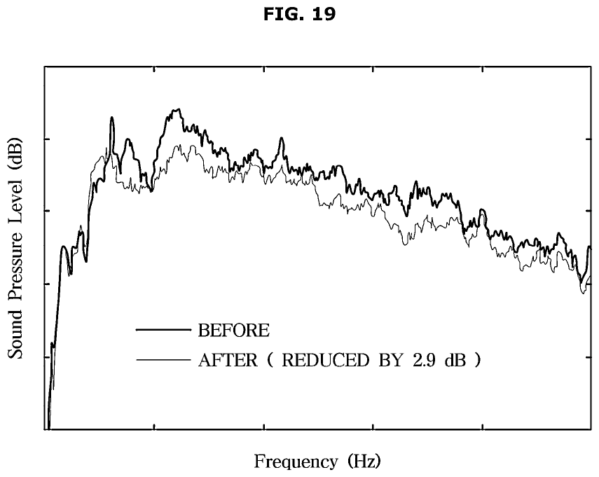

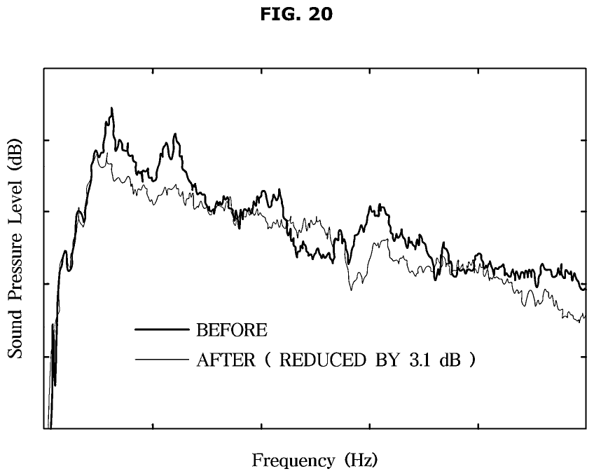

FIG. 18 is a cross-sectional view showing the filter air guide 300 and the fan air guide 300-1 shown in FIG. 4 and a component for reducing noise together. FIG. 19 is a graph showing a noise reduction effect by the filter air guide 300 and the fan air guide 300-1 shown in FIG. 18 in the front direction of the air cleaner AL. FIG. 20 is a graph showing a noise reduction effect by the filter air guide 300 and the fan air guide 300-1 shown in FIG. 18 in the rear direction of the air cleaner AL.

According to the air cleaner AL including the filter air guide 300 and the fan air guide 300-1 according to an embodiment of the disclosure, a noise reduction effect will be described with reference to FIGS. 18 to 20.

After the filter air guide 300 and the fan air guide 300-1 are installed in the air cleaner AL, as shown in FIG. 18, an experiment of measuring noise has been conducted. In the experiment, flow velocities of air have been designed to be 1 m/s immediately after the air passes through the filter 200, 10 m/s at the fan inlet 100Aa, and 15 m/s at the fan outlet 100Ab. The X axis of the shown graphs represents frequency, and the Y axis of the graphs represents sound level. The X axis represents 500 Hz per one unit, and the Y axis represents 10 dB per one unit.

As shown in FIG. 19, according to the installation of the filter air guide 300 and the fan air guide 300-1, a sound level of 2.9 dB on average has been reduced in the front direction of the air cleaner AL.

As shown in FIG. 20, according to the installation of the filter air guide 300 and the fan air guide 300-1, a sound level of 3.1 dB on average has been reduced in the rear direction of the air cleaner AL.

In summary, noise has been reduced in the front and rear directions of the air cleaner AL by the filter air guide 300 and the fan air guide 300-1.

So far, the air cleaner AL or the noise reduction apparatus according to an embodiment of the disclosure has been described. Hereinafter, an air cleaner AL or a noise reduction apparatus according to another embodiment of the disclosure will be described. In the following descriptions about the other embodiment, the same components as those of the embodiments described above with reference to FIGS. 1 to 20 will be assigned the same reference numerals as those assigned in the embodiments, and descriptions thereof will be omitted.

FIG. 21 is a cross-sectional view of a filter air guide 300-2 of an air cleaner AL according to an embodiment of the disclosure.

An air guide AG according to an embodiment of the disclosure will be described with reference to FIG. 21.

As shown in FIG. 21, the filter air guide 300-2 may include a plurality of first sound absorption holes 310H′-2 and a plurality of second sound absorption holes 310H″-2.

A density of the plurality of first sound absorption holes 310H′-2 for each unit area of the guide portion 310 may be different from a density of the plurality of second sound absorption holes 310H″-2 for each unit area of the guide portion 310. For example, as shown in FIG. 21, the plurality of first sound absorption holes 310H′-2 may be positioned below the plurality of second sound absorption holes 310H″-2 and have a lower density than the plurality of second sound absorption holes 310H″-2. Accordingly, the filter air guide 300-2 may have a preset range of resonant frequency.

The fan air guide 300-1 may also have the plurality of first sound absorption holes 310H′-2 and the plurality of second sound absorption holes 310H″-2 having a different density from the plurality of first sound absorption holes 310H′-2.

That is, the air guide AG may have the plurality of first sound absorption holes 310H′-2 and the plurality of second sound absorption holes 310H″-2 having a different density from the plurality of first sound absorption holes 310H′-2.

FIG. 22 is a cross-sectional view of a filter air guide 300-3 of the air cleaner AL according to an embodiment of the disclosure.

An air guide AG according to an embodiment of the disclosure will be described with reference to FIG. 22.

As shown in FIG. 22, the filter air guide 300-3 may include a first sound absorption hole 310H′-3 and a second sound absorption hole 310H″-3.

A diameter of the first sound absorption hole 310H′-3 may be different from a diameter of the second sound absorption hole 310H″-3. For example, as shown in FIG. 22, the first sound absorption hole 310H′-3 may be positioned below the second sound absorption hole 310H″-3, and have a smaller diameter than the first sound absorption hole 310H″-3. Accordingly, the filter air guide 300-2 may have a preset range of resonant frequency.

The fan air guide 300-1 may also have the first sound absorption hole 310H′-3 and the plurality of second sound absorption holes 310H″-3 having a different diameter from the first sound absorption hole 310H′-3.

That is, the air guide AG may have the first sound absorption hole 310H′-3 and the plurality of second sound absorption holes 310H″-3 having a different diameter from the first sound absorption hole 310H′-3.

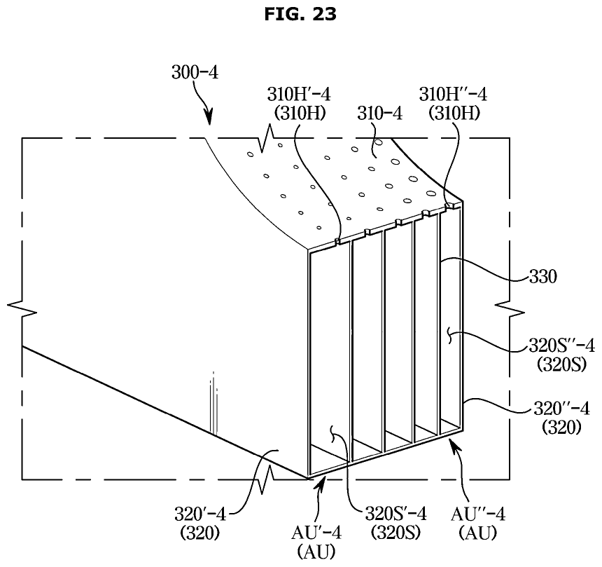

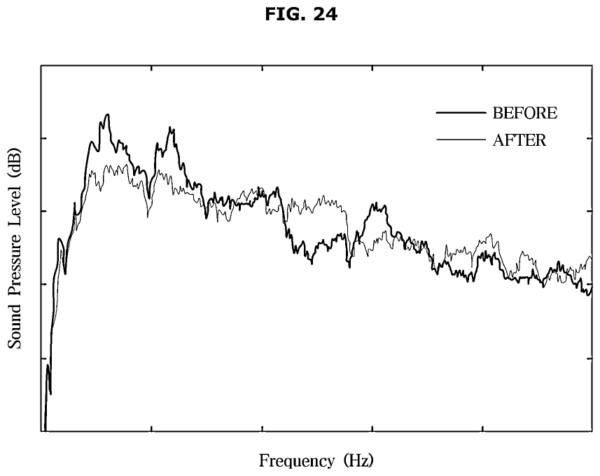

FIG. 23 is an enlarged perspective view of a filter air guide 300-4 of an air cleaner AL according to an embodiment of the disclosure. FIG. 24 is a graph showing a noise reduction effect by the filter air guide 300-4 shown in FIG. 23.

An air guide AG according to an embodiment of the disclosure will be described with reference to FIGS. 23 and 24.

As shown in FIG. 23, the filter air guide 300-4 may include a plurality of sound insulation units AU. The plurality of sound insulation units AU may include a first sound insulation unit AU′-4 and a second sound insulation unit AU″-4.

The first sound insulation unit AU-4′ may include a first sound absorption hole 310H′-4 and a first sound insulation space 320S.

The second sound insulation unit AU″-4 may include a second sound absorption hole 310H″-4 and a second sound insulation space 320S.

In the filter air guide 300-4 according to an embodiment of the disclosure, one sound absorption hole 310H may correspond to one sound insulation space 320S. In the filter air guide 300-4 according to the embodiment described above with reference to FIGS. 1 to 20, a plurality of sound absorption holes 310H may correspond to one sound insulation space 320S.

This structure is called a Helmholtz resonance structure.

The filter air guide 300-4 may include a separating partition 330 that partitions the first sound insulation unit AU′-4 from the second sound insulation unit AU″-4.

For the sound insulation units AU to have different resonant frequencies, the sound absorption holes 310H may have different sizes or different lengths, or the sound insulation spaces 320S may have different volumes. That is, a volume of a first sound insulation space 320S′-4 may be different from a volume of a second sound insulation space 320S″-4. For the volume of a first sound insulation space 320S′-4 to be different from the volume of a second sound insulation space 320S″-4, a first space forming portion 320′-4 may be different from a second space forming portion 320″-4.

Furthermore, each of the sound insulation units AU may include another Helmholtz resonance structure.

The Helmholtz resonance structure may also be applied to the fan air guide 300-1.

Accordingly, the air guide AG may have the sound absorption hole 310H corresponding one-to-one to the sound insulation space 320S to have a Helmholtz resonance structure.

After the fan air guide 300-1 as shown in FIG. 23 is installed, an experiment has been conducted. In the experiment, flow velocities of air have been designed to be 1 m/s immediately after the air passes through the filter 200, 10 m/s at the fan inlet 100Aa, and 15 m/s at the fan outlet 100Ab. The X axis of the shown graph represents frequency, and the Y axis of the graph represents sound level. The X axis represents 500 Hz per one unit, and the Y axis represents 10 dB per one unit.

As shown in FIG. 24, according to installation of the filter air guide 300-4, a noise reduction effect of maximally 8 dB has been obtained compared to the case in which the filter air guide 300-4 is not installed.

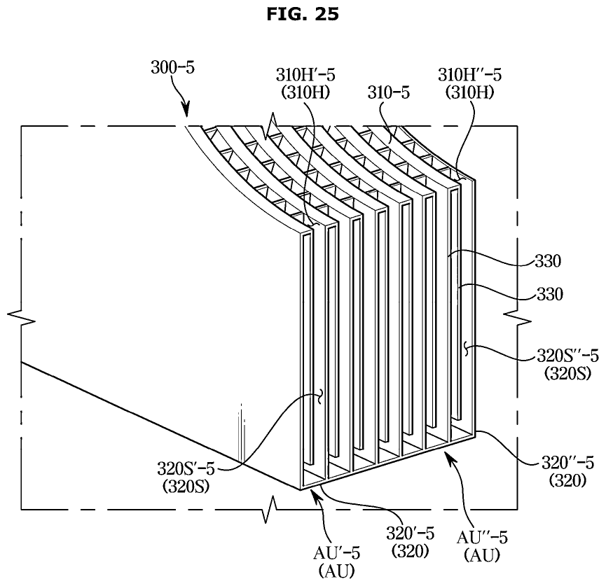

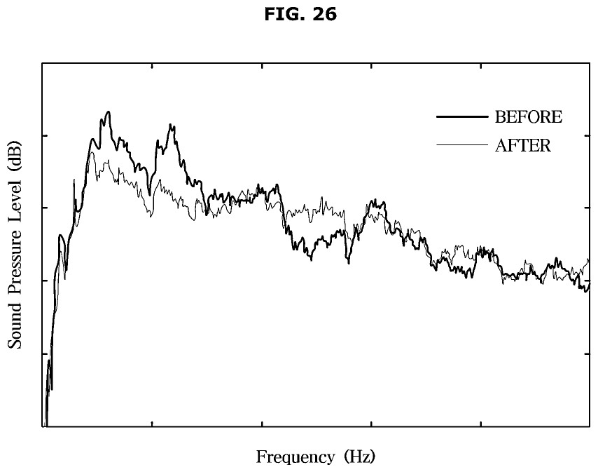

FIG. 25 is an enlarged perspective view of a filter air guide 300-5 of an air cleaner AL according to an embodiment of the disclosure. FIG. 26 is a graph showing a noise reduction effect by the filter air guide 300-5 shown in FIG. 25.

An air guide AG according to an embodiment of the disclosure will be described with reference to FIGS. 25 and 26.

As shown in FIG. 25, the filter air guide 300-5 may include a plurality of sound insulation units AU. The plurality of sound insulation units AU may include a first sound insulation unit AU′ and a second sound insulation unit AU″.

The first sound insulation unit AU′ may include a first sound absorption hole 310H′ and a first sound insulation space 320S.

The second sound insulation unit AU″ may include a second sound absorption hole 310H″ and a second sound insulation space 320S.

In the filter air guide 300-5 according to an embodiment of the disclosure, one sound absorption hole 310H may correspond to one sound insulation space 320S. In the filter air guide 300-5 according to the embodiment described above with reference to FIGS. 1 to 20, a plurality of sound absorption holes 310H may correspond to one sound insulation space 320S.

However, a difference from the embodiment described with reference to FIGS. 22 and 23 may be that a length of the sound insulation space 320S corresponds to ¼ of a length of a target wavelength. That, according to the length of the sound insulation space 320S being the length of ¼ of the target wavelength, a sound wave having the corresponding wavelength is absorbed as described above with reference to FIG. 8. In other words, the length of the sound insulation space 320S may be ¼ of a wavelength of a sound generated while the fan 100 operates.

As described above, extending the sound insulation space 320S to the length of ¼ of the wavelength may increase the size of the air guide AG. Accordingly, the sound insulation space 320S may extend in one direction and then extend in an opposite direction of the one direction. Because this structure seen from the side looks like a folding structure, the sound insulation space 320S may be referred to as being folded.

In this case, the sound insulation space 320S may have a constant width along the extension direction. The reason may be because the sound insulation spaces 320S having different widths in the extension direction are difficult to absorb sounds properly.

The filter air guide 300-5 may include a separating partition 330 that partitions the first sound insulation unit AU′ from the second sound insulation unit AU″.

For the sound insulation units AU to have different resonant frequencies, the sound absorption holes 310H may have different sizes and different lengths, or the sound insulation spaces 320S may have different volumes. That is, a volume of a first sound insulation space 320S′-5 may be different from a volume of a second sound insulation space 320S″-5. For the volume of the first sound insulation space 320S′-5 to be different from the volume of the second sound insulation space 320S″-5, a first space forming portion 320′-5 may be different from the second space forming portion 320″-5.

The air guide AG may include a separating partition 330 that partitions an area of the sound insulation space 320S extending in one direction from another area of the sound insulation space 320S extending in another direction that is opposite to the one direction.

Because the separating partition 330 may be configured to divide each sound insulation space 320S, each sound insulation space 320S extending from a sound absorption hole 310H corresponding to the sound insulation space 320S may vary in length to a wall of the sound insulation space 320S. Accordingly, the respective sound insulation spaces 320S may have different resonant frequencies. Accordingly, the air guide AG may have a preset range of resonant frequency. The air guide AG may absorb sound waves having a preset range of frequency.

After the fan air guide 300-5 as shown in FIG. 26 is installed, an experiment has been conducted. In the experiment, flow velocities of air have been designed to be 1 m/s immediately after the air passes through the filter 200, 10 m/s at the fan inlet 100Aa, and 15 m/s at the fan outlet 100Ab. The X axis of the shown graph represents frequency, and the Y axis of the graphs represents sound level. The X axis represents 500 Hz per one unit, and the Y axis represents 10 dB per one unit.

As shown in FIG. 26, according to installation of the filter air guide 300, a noise reduction effect of maximally 10 dB has been obtained compared to the case in which the filter air guide 300 is not installed.

The embodiment of the disclosure described above may be expressed as follows.

An air cleaner AL according to an embodiment of the disclosure may include a housing 10 having a flow path 10P through which air is movable, a fan 100 configured to operate to move air through the flow path 10P, and an air guide AG positioned adjacent to the fan 100, the air guide AG including a guide portion 310 having a guide surface 310A along which air flows while the fan 100 operates, wherein the guide portion 310 may have a sound absorption hole 310H configured to absorb a sound generated while the fan 100 operates, and the guide portion 310 may form a sound insulation space 320S communicating with the sound absorption hole 310H.

A volume of the sound absorption hole 310H may be smaller than a volume of the sound insulation space 320S to prevent a sound wave generated while the fan 100 operates from moving from the sound insulation space 320S through the sound absorption hole 310H.

The air guide AG may have a resonant frequency defined by the sound absorption hole 310H and the sound insulation space 320S, and the air guide AG may reduce a sound generated while the fan 100 operates according to a frequency of the sound being identical to the resonant frequency of the air guide AG.

The air guide AG may further include a space forming portion 320 extending from the guide portion 310 and configured to form the sound insulation space 320S between the space forming portion 320 and the guide portion 310.

The air guide AG may include a separating partition extending from the space forming portion 320 toward the guide portion 310 to partition the sound insulation space 320S into a first sound insulation space 320S and a second sound insulation space 320S having a different volume from the first sound insulation space 320S, a first sound insulation unit AU′ defining the first sound insulation space 320S, and a second sound insulation unit AU″ defining the second sound insulation space 320S and having a different resonant frequency from a resonant frequency of the first sound insulation unit AU″.

The sound absorption hole 310H may include a plurality of first sound absorption holes 310H corresponding to the first sound absorption space 320S and a plurality of second sound absorption holes 310H corresponding to the second sound insulation space 320S, and the number of the plurality of first sound absorption holes 310H′ for a volume of the first sound insulation space 320S may be different from the number of the plurality of second sound absorption holes 310H″ for a volume of the second sound insulation space 320S such that the resonant frequency of the first sound insulation unit AU′ is different from the resonant frequency of the second sound insulation unit AU″.

The sound absorption hole 310H may include a first sound absorption hole 310H′ corresponding to the first sound insulation space 320S and a second sound absorption hole 310H″ corresponding to the second sound insulation space 320S, and a diameter of the first sound absorption hole 310H′ may be different from a diameter of the second sound absorption hole 310H″ such that the resonant frequency of the first sound insulation unit AU′ is different from the resonant frequency of the second sound insulation unit AU″.

To prevent a sound from resonating by air moving while the fan 10 operates, a diameter of the sound absorption hole 310H may be less than 2.0 mm.

The sound absorption hole 310H may penetrate the guide portion 310 to prevent a distance between two points on an opening of the sound absorption hole 310H from becoming greater than 2.0 mm.

The air guide AG may reduce a sound in a frequency region of 1000 Hz or less among frequencies of sounds generated while the fan 100 operates, and the air guide AG may have a meta structure in which a density of air being adjacent to the sound absorption hole 310H has a negative value.

The fan 100 may have a fan inlet 100Aa having a first cross-sectional area, the air cleaner (AL) may include a filter 200 spaced from the fan 100 and having a second cross-sectional area that is larger than the first cross-sectional area, and the guide portion 310 may include a guide flow path 310P of which a cross-sectional area is reduced toward the fan inlet 100Aa from the filter 200 to prevent, while the fan 100 operates, air passed through the filter 200 and then moving toward the fan inlet 100Aa from forming turbulence.

The fan 100 may include blades 110 and a shroud 120 positioned between the blades 110 and the air guide AG, the shroud 120 extending radially from a center of rotation of the blades 110 toward a fan outlet 100Ab along an axis of rotation of the blades 110, and the air guide AG may further include a flow induction flow path 311P of which a cross-sectional area increases gradually toward the shroud 120 from an end of the guide flow path 310P such that according to an operation of the fan 100, air moves in the extension direction of the shroud 120 while the air moves.

The sound absorption hole 310H may correspond one-to-one to the sound insulation space 320S such that the air guide AG has a Helmholtz resonance structure.

A length to which the sound insulation space 320S extends may be ¼ of a wavelength of a sound generated while the fan 100 operates.

The air guide AG may be spaced in a radial direction from the center of rotation of the fan 100 and extend in a circumferential direction, and the sound insulation space 320S may be positioned between the air guide AG and the housing 10.

An air cleaner AL according to an embodiment of the disclosure may include a housing 10 having an inlet 11S and an outlet 12S, a filter 200 positioned inside the housing 10, a fan 100 configured to move air from the filter 200 to the outlet 12S of the housing 10, the fan 100 having a fan inlet Aa through which air passes and which has a smaller cross-sectional area than a cross-sectional area of the filter 200, and an air guide AG positioned between the fan 100 and the filter 200, the air guide AG having a guide flow path 310P of which a cross-sectional area is reduced gradually toward the fan 100, wherein the air guide AG may have a sound absorption hole 310H configured to absorb a sound generated while the fan 100 operates and communicating with the sound insulation space 320S.

A volume of the sound absorption hole 310H may be smaller than a volume of the sound insulation space 320S to prevent a sound wave generated while the fan 100 operates from moving from the sound insulation space 320S through the sound absorption hole 310H.

The air guide AG may further include a space forming portion 320 to define the sound insulation space 320S between the air guide AG and the guide portion 310, and the air guide AG may include a separating partition extending from the space forming portion 320 toward the guide portion 310 to partition the sound insulation space 320S into a first sound insulation space 320S and a second sound insulation space 320S having a different volume from the first sound insulation space 320S, a first sound insulation unit AU′ defining the first sound insulation space 320S, and a second sound insulation unit AU″ defining the second sound insulation space 320S and having a different resonant frequency from a resonant frequency of the first sound insulation unit AU″.

The sound absorption hole 310H may include a plurality of first sound absorption holes 310H′ corresponding to the first sound absorption space 320S and a plurality of second sound absorption holes 310H″ corresponding to the second sound insulation space 320S, and the number of the plurality of first sound absorption holes 310H′ for a volume of the first sound insulation space 320S may be different from the number of the plurality of second sound absorption holes 310H″ for a volume of the second sound insulation space 320S such that the resonant frequency of the first sound insulation unit AU′ is different from the resonant frequency of the second sound insulation unit AU″.

A noise reduction apparatus according to an embodiment of the disclosure may include an air guide AG positioned adjacent to a fan 100, wherein the air guide AG may include a guide main body 310 and 320, a sound insulation space 320S positioned inside the guide main body 310 and 320, and a sound absorption hole 310H opening toward the fan 100 to absorb a sound generated while the fan 100 or a motor operates, communicating with the sound insulation space 320S, and having a smaller volume than the sound insulation space 320S.

The above-described embodiments can be combined with other embodiments unless clearly indicated otherwise. Alternatively, the embodiments can be combined with each other unless there are obvious limitations. Combinations of any embodiment and the other embodiments are considered to be disclosed in the present document.

So far, specific embodiments have been shown and described. However, the disclosure is not limited to the above-described embodiments, and various modifications can be made by those skilled in the art without departing from the gist of the technical idea of the disclosure defined by the claims below.

1. An air cleaner comprising:
a housing including a flow path through which air is movable;
a fan configured to operate to move air through the flow path; and
an air guide adjacent to the fan, the air guide including:
a guide surface along which the air moving through the flow path flows while the fan operates, and
a sound absorption hole extending from the guide surface so that a sound generated by the fan while the fan operates is absorbed through the sound absorption hole.

2. The air cleaner of claim 1, wherein
the air guide includes:
a guide portion including the guide surface and the sound absorption hole; and
a space forming portion defining the sound insulation space between the space forming portion and the guide portion,
wherein the guide surface is on one side of the guide portion which is opposite to another side of the guide portion facing the sound insulation, and
wherein the sound absorption hole extends from the guide surface through the guide portion to the sound insulation space.

3. The air cleaner of claim 2, wherein
a volume of the sound absorption hole is smaller than a volume of the sound insulation space, to thereby prevent a sound wave generated while the fan operates from moving from the sound insulation space through the sound absorption hole.

4. The air cleaner of claim 2, wherein
the air guide has a resonant frequency defined by the sound absorption hole and the sound insulation space so that, when a frequency of the generated sound is identical to the resonant frequency of the air guide, the air guide reduces the generated sound.

5. The air cleaner of claim 2, wherein
the air guide includes:
a separating partition extending from the space forming portion toward the guide portion and partitioning the sound insulation space into a first sound insulation space and a second sound insulation space having a different volume from the first sound insulation space,
a first sound insulation unit defining the first sound insulation space and having a resonant frequency, and
a second sound insulation unit defining the second sound insulation space and having a resonant frequency that is different from the resonant frequency of the first sound insulation unit.

6. The air cleaner of claim 5, wherein
the sound absorption hole is a sound absorption hole among a plurality of first sound absorption holes and a plurality of second sound absorption holes,
the plurality of first sound absorption holes correspond to the first sound insulation space,
the plurality of second sound absorption holes correspond to the second sound insulation space, and
a number of sound absorption holes of the plurality of first sound absorption holes for a volume of the first sound insulation space is different from a number of sound absorption holes of the plurality of second sound absorption holes for a volume of the second sound insulation space, such that the resonant frequency of the first sound insulation unit is different from the resonant frequency of the second sound insulation unit.

7. The air cleaner of claim 5, wherein
the sound absorption hole is a sound absorption hole among a plurality of sound absorption holes including:
a first sound absorption hole corresponding to the first sound insulation space, and
a second sound absorption hole corresponding to the second sound insulation space, and
a diameter of the first sound absorption hole is different from a diameter of the second sound absorption hole, such that the resonant frequency of the first sound insulation unit is different from the resonant frequency of the second sound insulation unit.

8. The air cleaner of claim 1, wherein
a diameter of the sound absorption hole is less than 2.0 mm, so as to prevent a sound from resonating by the air moving through the flow path while the fan operates.

9. The air cleaner of claim 1, wherein
the sound absorption hole penetrates the guide portion so as to prevent a distance between two points on an opening of the sound absorption hole from being greater than 2.0 mm.

10. The air cleaner of claim 1, wherein
the air guide is configured to reduce a sound in a frequency region of 1000 Hz or less among frequencies of sounds generated while the fan operates, and
the air guide has a meta structure in which a density of air being adjacent to the sound absorption hole has a negative value.

11. The air cleaner of claim 1, wherein
the fan includes a fan inlet having a first cross-sectional area,
a filter having a second cross-sectional area that is larger than the first cross-sectional area is installable in the air cleaner so as to be spaced apart from the fan, and
when the filter is installed in the air cleaner, the guide portion includes a guide flow path of which a cross-sectional area is reduced toward the fan inlet from the filter to prevent, while the fan operates, air passed through the filter and moving toward the fan inlet from forming turbulence.

12. The air cleaner of claim 11, wherein
the fan includes:
a blade,
a fan outlet, and
a shroud positioned between the blade and the air guide, the shroud extending radially from a center of rotation of the blade toward the fan outlet along an axis of rotation of the blade, and
the air guide includes:
a flow induction flow path of which a cross-sectional area increases gradually toward the shroud from an end of the guide flow path such that air moves in an extension direction of the shroud while the fan operates.

13. The air cleaner of claim 2, wherein
the sound absorption hole corresponds one-to-one to the sound insulation space such that the air guide includes a Helmholtz resonance structure.

14. The air cleaner of claim 2, wherein
a length to which the sound insulation space extends is ¼ of a wavelength of the generated sound.

15. The air cleaner of claim 1, wherein
the air guide is spaced in a radial direction from a center of rotation of the fan and extends about the center of rotation of the fan in a circumferential direction, and
the sound insulation space is positioned between the air guide and the housing.
